(19) United States
(12) Patent Application Publication
(10) Pub. No.: US 2023/0416447 A1
(43) Pub. Date: Dec. 28, 2023

(54) TOUGH, REPROCESSABLE ELASTOMERS AND METHODS OF MAKING AND USING SAME

(71) Applicants: UNIVERSITY OF BIRMINGHAM, Birmingham (GB); DUKE UNIVERSITY, Durham, NC (US)

(72) Inventors: Matthew L. BECKER, Durham, NC (US); Andrew P. DOVE, Birmingham (GB); Connor STUBBS, Birmingham (GB); Josh WORCH, Birmingham (GB); Hannah PRYDDERCH, Birmingham (GB)

(21) Appl. No.: 18/036,721

(22) PCT Filed: Nov. 11, 2021
(86) PCT No.: PCT/GB2021/052921

§ 371 Date: May 12, 2023

Related U.S. Application Data
(60) Provisional application No. 63/113,422, filed on Nov. 13, 2020.

(51) Int. Cl. C08G 18/32; C08G 75/04; C08L 75/04; C08G 18/81

(52) U.S. Cl. CPC C08G 18/3218; C08G 75/04; C08L 75/04; C08G 18/8116; C08G 2230/00; C08L 2201/06

(57) ABSTRACT

The present disclosure describes, in part, a polymer, for example a thermoplastic polyurethane elastomer, comprising one or more subunits comprising (i) at least one dianhydrohexitole moiety (ii) at least one urethane moiety and (ill) a thiol moiety having two or more sulphur atoms. The thermoplastic polyurethane elastomers may be biodegradable and possess excellent thermoplastic properties, including outstanding toughness, resulting from its semi-crystallinity and low glass transition temperature, that surpasses many leading plastics such as nylon 6 and high-density polyethylene (HOPE) and methods of making same.

### BACKGROUND

The remarkable mechanical properties of elastomers found in nature are characterized by high elasticity and tensile strength that are difficult to mimic using synthetic methods. Traditional synthetic strategies to reproduce these properties focus primarily on the use of chemically crosslinked networks, hydrogen bonding or increasing the content of crystalline domains. While useful, these strategies have significant drawbacks including limited end-of-life options, reduced optical clarity upon deformation, and a tradeoff between strength and extensibility.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

The present disclosure is based, in part, on the findings by the inventors of the synthesis of thermoplastic polyurethane (TPU) elastomers comprising renewably sourced 1,4:3,6-dianhydrohexitols stereoisomers that display exceptional strength and elongation at break that is superior to both natural and synthetic commercial rubbers and thermoplastic elastomers. The unique combination of the rigid ring structures adjacent to distinct and strong hydrogen bonding interfaces imparted by the stereochemical configuration are shown to impart unique material properties including strain rate dependent behavior, significant strain hardening, and high optical clarity that is retained throughout elongation. These phenomena are attributed to dynamic transitions between intra- and inter-molecular hydrogen bonding in the transient crosslinking network, as revealed by computational and experimental investigations. In addition to the renewably sourced feedstock, the self-organization of the stereochemically-defined sugar units and high thermal stability of these materials facilitate facile reprocessing with minimal loss of mechanical performance, making them excellent candidates for sustainable alternatives to commodity elastomers.

Accordingly, one aspect of the present disclosure provides a biodegradable thermoplastic polyurethane (TPU) polymer that is the reaction product of reactants comprising, consisting of, or consisting essentially of: (a) an acrylate-terminated monomer, wherein the acrylate-terminated monomer comprises: (i) at least one dianhydrohexitole and (ii) at least one urethane group, in which the ring structure of the dianhydrohexitole and the urethane groups facilitate stereoisomer dependent dynamic crosslinking of the materials via hydrogen bonding; (b) a thiol selected from the group consisting of a linear dithiol, a branched tri-thiol, and a branched tetra-thiol; and (c) a catalytic quantity of an aromatic alkylphosphine.

Another aspect of the present disclosure provides a biodegradable thermoplastic polyurethane (TPU) polymer obtainable by reacting: (a) an acrylate-terminated monomer comprising, consisting of, or consisting essentially of: (i) at least one dianhydrohexitole and (ii) at least one urethane group, in which the ring structure of the dianhydrohexitole and the urethane groups facilitate stereoisomer dependent dynamic crosslinking of the materials via hydrogen bonding; (b) a thiol selected from the group consisting of a linear dithiol, a branched tri-thiol, and a branched tetra-thiol; and (c) catalytic quantity of an alkylphosphine in a phosphine-mediated thiol-ene addition polymerization process.

In one embodiment, the at least one dianhydrohexitole comprises 1,4:3,6-dianhydrohexitol. In some embodiments, the 1,4:3,6-dianhydrohexitol molecule comprises an isoform selected from the group consisting of isoborbide (1,4:3,6-dianhydro-D-glucitol), isomannide (1,4:3,6-dianyhydro-D-mannitol), and isoidide (1,4:3,6-dianhydro-L-idotol).

Any number of different thiols can be used in the compositions and methods of the present disclosure. In some embodiments, the thiol is selected from the group consisting of 1,8-octanedithiol, 1,4-butanedithiol, 1,6-hexanedithiol, 1,10-decanedithiol, 1,12-dodecandithiol and the like.

In another embodiment, the alkylphosphine comprises an organic base. In some embodiments, the organic base comprises dimethylphenyl phosphine.

In another embodiment, polymer comprises a tensile strength of at least 55 MPa.

In another embodiment, the polymer comprises a homopolymer comprising one or more identical subunits. In one embodiment, the homopolymer comprising subunits comprising isosorbide polyurethane (ISPU) having the general formula (I)

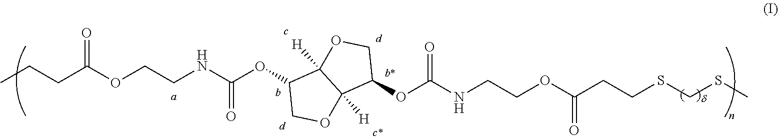

and any derivatives thereof. In another embodiment, the homopolymer comprising subunits comprising isomannide polyurethane (IMPU) having the general formula (II)

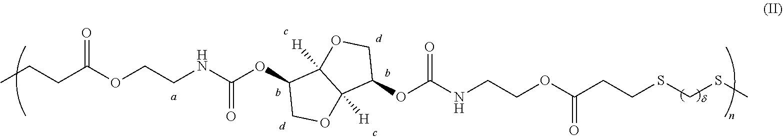

and any derivatives thereof. In yet another embodiment, the homopolymer comprising subunits comprising polyurethane-containing isodide (IIPU) having the general formula (III)

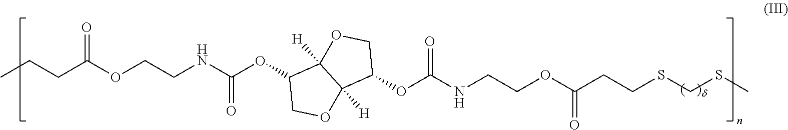

and derivatives thereof.

In another embodiment, the polymer comprises a copolymer, the copolymer comprising one or more different polymer subunits joined together create the copolymer.

In one embodiment, the copolymer comprises one or more subunits selected from the group consisting of: isosorbide polyurethane (ISPU) having the general formula (I)

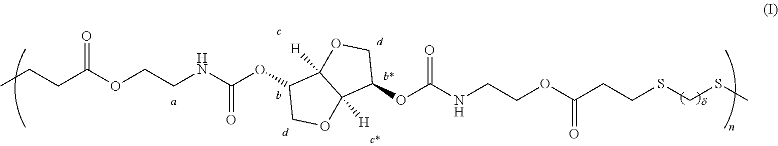

and any derivatives thereof; isomannide polyurethane (IMPU) having the general formula (II)

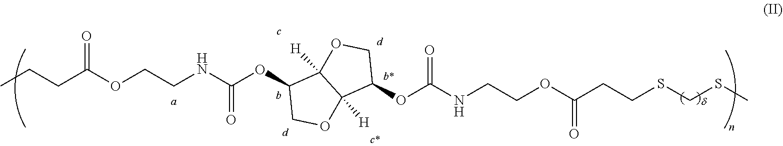

and any derivatives thereof, and polyurethane-containing isodide (IIPU) having the general formula (III)

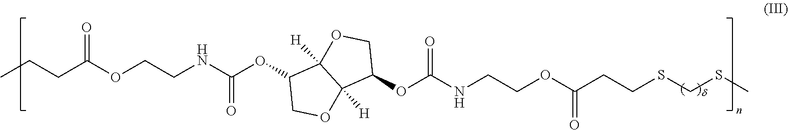

and derivatives thereof.

In some embodiments, the copolymer comprises a blend of isodide (II) and isomannide (IM). In one embodiment, the copolymer comprises a blend of isodide (II) and isomannide (IM) at a ratio of 75:25 (co-II₇₅IM₂₅). In another embodiment, the copolymer comprises a blend of isodide (II) and isomannide (IM) at a ratio of 25:75 (co-II₂₅IM₇₅). In yet another embodiment, the copolymer comprises a blend of isodide (II) and isomannide (IM) at a ratio of 50:50 (co-II₅₀IM₅₀). A further aspect may provide a polymer, for example a thermoplastic polyurethane elastomer, comprising one or more subunits comprising (i) at least one dianhydrohexitole moiety (ii) at least one urethane moiety and (iii) a thiol moiety having two or more sulphur atoms.

The subunits preferably comprise a rigid (or at least relatively rigid) dianhydrohexitole moiety on one side, and preferably on either side, of which is or are provide a urethane moiety, which may be considered to provide a ‘hard’ segment.

The at least one dianhydrohexitole moiety may be a 1,4:3,6-dianhydrohexitol moiety. The dianhydrohexitole moiety may comprise one or more of isodide, isosorbide and isomannide.

In an embodiment the thiol moiety may be linear or branched, for example a linear dithiol, a branched tri-thiol, and a branched tetra-thiol. The thiol moiety may be selected from the group consisting of 1,8-octanedithiol, 1,4-butanedithiol, 1,6-hexanedithiol, 1,10-decanedithiol, 1,12-dodecandithiol. The thiol moiety may be alkyl. The thiol moiety may comprise from 4 to 12 carbon atoms.

The urethane moiety may be derived from an aliphatic or aromatic isocyanate, preferably aliphatic.

The isocyanate may be a diisocyante or a monoisocyanate. The isocyanate may be selected from IPDI, MDI, HDI, TDI. In a specific example the isocyanate may be 2-isocyantoethylacrylate.

The thermoplastic polyurethane elastomer may also comprise an acrylate moiety. The acrylate may be an acrylate, methacrylate or ethacrylate moiety.

The thermoplastic polyurethane elastomer may comprise one or more of subunits which are selected from:

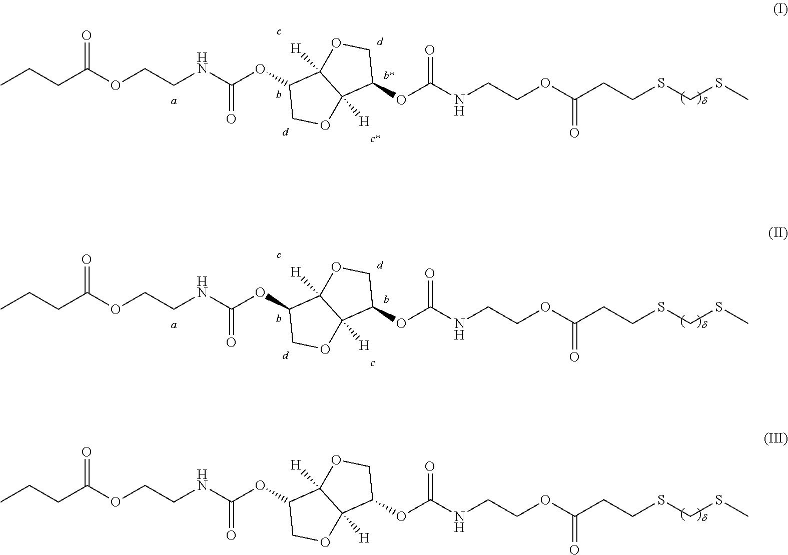

or derivatives thereof and wherein 6 is from 4 to 12.

The thermoplastic polyurethane elastomer may comprise a homopolymer of each of said subunits or a copolymer comprising one or more of said subunits (I), (II), (III). For example, a copolymer may comprise at least two different subunits selected from said subunits (I), (II), (III). In an embodiment the copolymer may comprise isodide and isomannide. For example the copolymer may comprise a blend of isodide (II) and isomannide (IM) at a ratio of 75:25 (co-II₇₅IM₂₅) or a blend of isodide (II) and isomannide (IM) at a ratio of 25:75 (co-II₂₅IM₇₅) or a blend of isodide (II) and isomannide (IM) at a ratio of 50:50 (co-II₅₀IM₅₀).

The thermoplastic polyurethane elastomer may be biodegradeable.

Another aspect of the present disclosure provides an article comprising, consisting of, or consisting essentially of a plurality of biodegradable thermoplastic polyurethane (TPU) polymers as provided herein. In some embodiments, the article comprises a polymer having a plurality of hard segments, each hard segment separated by a rigid 1,4:3,6-dianhydrohexitol molecule.

In another embodiment, the article comprises a plurality of biodegradable thermoplastic polyurethane (TPU) copolymers as provided herein.

In another embodiment, the article comprises a physical blend of two or more different biodegradable thermoplastic polyurethane (TPU) polymers and/or copolymers as provided herein.

Another aspect of the present disclosure provides a film comprising, consisting of, or consisting essentially of a plurality of biodegradable thermoplastic polyurethane (TPU) polymers as provided herein.

In one embodiment, the film comprises a polymer having a plurality of hard segments, each hard segment separated by a rigid 1,4:3,6-dianhydrohexitol molecule.

In another embodiment, the film comprises a plurality of biodegradable thermoplastic polyurethane (TPU) copolymers as provided herein.

In another embodiment, the film comprises a physical blend of two or more different biodegradable thermoplastic polyurethane (TPU) polymers and/or copolymers as provided herein.

Another aspect of the present disclosure provides a method of making a biodegradable thermoplastic polyurethane (TPU) polymer as provided herein, the method comprising, consisting of, or consisting essentially of reacting an (a) acrylate-terminated monomer comprising, consisting of, or consisting essentially of: (i) at least one dianhydrohexitole and (ii) at least one urethane group; (b) a thiol; and (c) a catalytic quantity of an alkylphosphine in a base-mediated thiol-ene addition polymerization process.

In one embodiment, the thiol is selected from the group consisting of a linear dithiol, a branched tri-thiol, and a branched tetra-thiol.

Another aspect of the present disclosure provides all that is described and illustrated herein.

### BRIEF DESCRIPTION OF THE DRAWINGS

The accompanying Figures and Examples are provided by way of illustration and not by way of limitation. The foregoing aspects and other features of the disclosure are explained in the following description, taken in connection with the accompanying example figures (also “FIG.”) relating to one or more embodiments, in which:

FIG. 1 are schematics and graphs showing (a) synthesis of acrylate terminated isoidide monomer and step-growth polyaddition to afford IIPU; (b) representative stress vs strain curves of IIPU, HDPE and Nylon-6 tested at 10 mm min⁻¹ and 22° C.; (c) three-dimensional energy optimized structure of one repeat unit of IIPU showing different orientation of polymer backbone according to relative sterechemistries; and (d) bottom—summary of thermomechanical properties for reported plastics in accordance with one aspect of the present disclosure (^{a}Young's modulus ^{b}Ultimate tensile strength ^{c}Strain at breakage ^{d}Tensile toughness. ^{†}Recently reported example of a degradable Nylon mimic, isotactic polypropylene oxide (iPPO));

FIG. 2 are graphs showing: (a) DSC thermogram cycles of annealed (3 day) IIPU and IMPU (solid line=heating scan and dashed line=cooling scan); (b) representative stress vs strain curves obtained at 10 mm min⁻¹, 22° C. for annealed IIPU and IMPU with Young's modulus (E) displayed; and (c) time-temperature superposition of rheological frequency sweeps of IIPU and IMPU overlaid at 130° C. in accordance with one embodiment of the present disclosure (chain entanglement molecular weight (Me) of IIPU and IMPU is displayed);

FIG. 3 are schematics and graphs showing: (a) snapshots illustrating conformational changes of IIPU macromolecules under deformation; and (b) dependence of the ratio of the intermolecular (Ninter) hydrogen bonds to intramolecular (Nintra) ones on deformation for IIPU (b) and IMPU (c) systems in accordance with one embodiment of the present disclosure (data averaged over 20 different simulation runs from undeformed state);

FIG. 4 are graphs showing visual representation of copolymers vs physical blends in accordance with one embodiment of the present disclosure. DSC heating scans of annealed (a) random copolymers (b) physical blends. Total enthalpy of melting (ΔHm) calculated from integration of all thermal transitions. The IIPU forms significant crystal domains which strongly influence the mechanical properties while the IMPU does not. Representative stress vs strain tensile curves of annealed (c) random copolymers (d) physical blends. (n>3) Mechanical testing was performed at 10 mm min⁻¹;

FIG. 5 are graphs showing: (a) normalized weight loss of IIPU, IMPU, co-II₅₀IM₅₀ and b-II₅₀IM₅₀ discs in 1 M NaOH over 45 days. n=3; (b) DSC heating scans of annealed IIPU, IMPU, co-II₅₀IM₅₀ and b-II₅₀IM₅₀ where total enthalpy of melting (ΔHm) is calculated from integration of all thermal transitions; and (c) representative stress vs strain tensile curves of annealed IIPU, IMPU, co-II₅₀IM₅₀ and b-II₅₀IM₅₀ wherein when blended, the IIPU is able to form significant crystalline domains and retain the plastic behavior seen in the homopolymer systems in accordance with one embodiment of the present disclosure;

FIG. 6 are NMR spectra graphs showing: A) thiolene polymerization of acrylated isohexide isomers with distinct stereochemistry yielding isosorbide polyurethane (ISPU) and isomannide polyurethane (IMPU) where the space filling models of the polymer chains from atomistic simulations to show how the stereochemistry of the 1,4:3,6-dianhydrohexitol unit affects the relaxed chain configuration and B)¹H NMR spectra of ISPU and IMPU with inset figures highlighting the stereochemical differences in accordance with one embodiment of the present disclosure;

FIG. 7 are graphs showing: A) representative stress vs. strain curve used to highlight the different strain dependent deformation regimes observed in ISPU and IMPU; B) representative ISPU and IMPU tensile data comparing the effects of 1,4:3,6-dianhydrohexitol stereochemistry and deformation speed on mechanical performance (22° C., n=3, annealed at 25° C. for 7 d after pressing); C) images of ISPU and IMPU films prior to stretching and while being stretched to 800% strain continue to show optical clarity (0.25 mm thick at 0% strain); and D) comparison of zero-force stress recovery after tensile stretching to 750% as a function of strain rate in ISPU and IMPU (22° C., samples annealed at 25° C. for 7 d after pressing) in accordance with one embodiment of the present disclosure;

FIG. 8 are schematics and graphs showing: A) simulation snapshots of ISPU chain deformations; B) evolution of the ratio Ninter/Nintra of interchain H-bonds, Ninter, to intrachain H-bonds, Nintra, as a function of strain in ISPU; C) IMPU—Comparison of SAXS patterns of ISPU and IMPU during tensile stretching at a rate of 10 mm/min, with arrows designating the axis of deformation; D) SAXS intensity profile of ISPU at different strains after tensile stretching at a rate of 10 mm/min where the inset figure shows the change in domain spacing during deformation as determined by SAXS; and E) WAXS intensity profile of ISPU at different strains after tensile stretching at a rate of 10 mm/min in accordance with one embodiment of the present disclosure;

FIG. 9 are schematics and graphs showing: A) 2D SAXS patterns of ISPU and IMPU during tensile elongation where samples were stretched at a rate of 10 mm/min and the black arrows show the axis of deformation; B) comparison of intra- and inter-chain bond evolution during the atomistic simulation of the extension of ISPU and IMPU; and C) schematics of ISPU and IMPU chains at different strains comparing hydrogen bond evolution, suggested by data from scattering experiments and simulations in accordance with one embodiment of the present disclosure;

FIG. 10 are schematics and graphs showing: A) scheme showing structures of ISPU, IMPU, ISNU, SAT PU; and B) representative stress vs. strain curves obtained by tensile testing of ISPU, IMPU, ISNU, and SAT PU films, demonstrating that the mechanical performance of ISPU and IMPU is derived from the combination of the urethane groups and the sugar units. (22° C., n=3, strained at 10 mm/min, annealed at 25° C. for 7 d after pressing) in accordance with one embodiment of the present disclosure; and

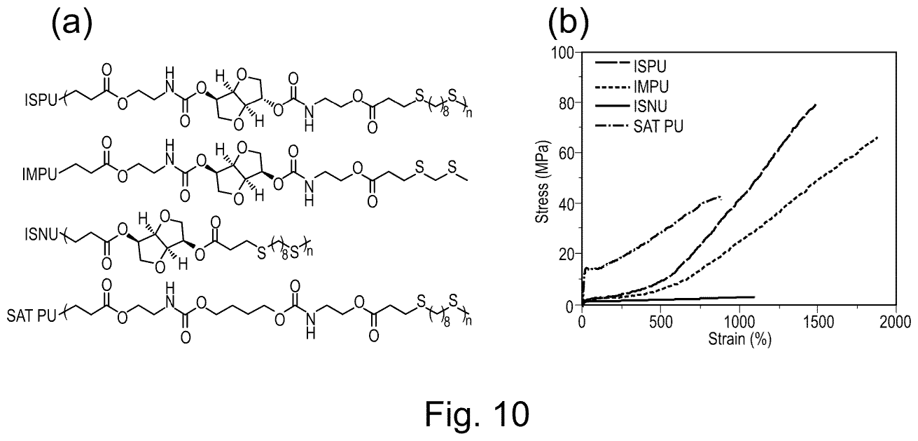

FIG. 11 is a graph showing representative stress vs. strain curves obtained by tensile testing of IMPU films after repeated thermal processing in a heated press at 100° C. where scraps from the initial press and broken tensile samples were used to make samples. (22° C., strained at rate of 10 mm min−1, samples annealed at 25° C. for 7 d after pressing, n=3) in accordance with one embodiment of the present disclosure.

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. Byway of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification.

These are only examples of what is specifically intended, and all possible combinations of numerical values between and including the lowest value and the highest value enumerated are to be considered to be expressly stated in this disclosure.

It will be understood that, when describing the number of carbon atoms in a substituent group (e.g. ‘C1 to C6’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

Many of the chemicals which may be used to produce the polyurethane of the present disclosure are obtained from natural sources. Such chemicals typically include a mixture of chemical species due to their natural origin. Due to the presence of such mixtures, various parameters defined herein can be an average value and may be non-integral.

As used herein, the term “polymer” refers to a substance that has a molecular structure consisting chiefly or entirely of a large number of similar units/subunits that are joined/bonded together.

Unless otherwise defined, all technical terms used herein have the same meaning as commonly understood by one of ordinary skill in the art to which this disclosure belongs.

The present disclosure provides, in part, a biodegradable thermoplastic polyurethane (TPU) elastomer that possess excellent thermoplastic properties, including outstanding toughness, resulting from its semi-crystallinity and low glass transition temperature, that surpasses many leading plastics such as nylon 6 and high-density polyethylene (HDPE). Without being bound by theory, it is understood that hydrogen bonds may vary in strength from weak to strong, and the unique combination of the rigid ring structures adjacent to distinct and strong hydrogen bonding interfaces imparted by the stereochemical configuration of the TPUs provided herein are shown to impart unique material properties including strain rate dependent behavior, significant strain hardening, and high optical clarity that is retained throughout elongation.

Polyurethanes are a versatile class of polymers that utilize interplay between “hard blocks” and “soft blocks” to access diverse material properties. Without being bound by theory, the polyurethanes provided herein have high molecular masses and alternating sequences of urethane and isohexide groups (e.g., dianhydrohexitoles) instead of traditional block structures. This combination of urethane and isohexide groups physically crosslink the polyurethanes with a dynamic hydrogen bonding network that imparts outstanding strength, toughness, extensibility, and high optical clarity.

Films may be 500 μm thick or thinner, preferably 200 μm thick or thinner.

Viewed from a first aspect, the present disclosure provides a biodegradable thermoplastic polyurethane (TPU) polymer that is the reaction product of reactants comprising, consisting of, or consisting essentially of: (a) an acrylate-terminated monomer, wherein the acrylate-terminated monomer comprises: (i) at least one dianhydrohexitole and (ii) at least one urethane group, in which the ring structure of the dianhydrohexitole and the urethane groups facilitate stereoisomer dependent dynamic crosslinking of the materials via hydrogen bonding; (b) a thiol selected from the group consisting of a linear dithiol, a branched tri-thiol, and a branched tetra-thiol; and (c) a catalytic quantity of an aromatic alkylphosphine.

Another aspect of the present disclosure provides a biodegradable thermoplastic polyurethane (TPU) polymer obtainable by reacting: (a) an acrylate-terminated monomer comprising, consisting of, or consisting essentially of: (i) at least one dianhydrohexitole and (ii) at least one urethane group, in which the ring structure of the dianhydrohexitole and the urethane groups facilitate stereoisomer dependent dynamic crosslinking of the materials via hydrogen bonding; (b) a thiol selected from the group consisting of a linear dithiol, a branched tri-thiol, and a branched tetra-thiol; and (c) catalytic quantity of an alkylphosphine in a phosphine-mediated thiol-ene addition polymerization process.

In one embodiment, the at least one dianhydrohexitole comprises 1,4:3,6-dianhydrohexitol. In some embodiments, the 1,4:3,6-dianhydrohexitol molecule comprises an isoform selected from the group consisting of isoborbide (1,4:3,6-dianhydro-D-glucitol), isomannide (1,4:3,6-dianyhydro-D-mannitol), and isoidide (1,4:3,6-dianhydro-L-idotol).

Any number of different thiols can be used in the compositions and methods of the present disclosure. Suitable examples include, but are not limited to, 1,8-octanedithiol, 1,4-butanedithiol, 1,6-hexanedithiol, 1,10-decanedithiol, 1,12-dodecandithiol and the like.

In another embodiment, the alkylphosphine comprises an organic base. Suitable organic bases include, but are not limited to, dimethylphenyl phosphine and the like.

The thermoplastic polymers according to the present disclosure possess excellent thermoplastic properties including outstanding toughness, resulting from its semi-crystallinity and low glass transition temperature that surpasses many leading plastics such as nylon 6 and high-density polyethylene (HDPE). Hence, in another embodiment, polymer comprises a tensile strength of at least 55 MPa.

In some embodiments, the polymers according to the present disclosure comprises a homopolymer comprising one or more identical subunits. In one embodiment, the polymer as provided herein comprises a homopolymer having subunits comprising isosorbide polyurethane (ISPU) and having the general formula (I)

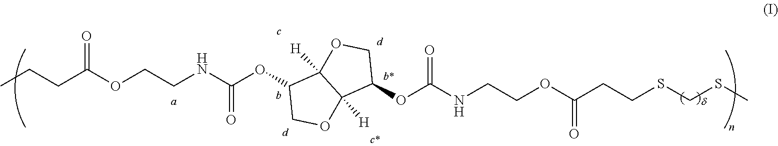

and any derivatives thereof. In another embodiment, the polymer as provided herein comprises a homopolymer having subunits comprising isomannide polyurethane (IMPU) having the general formula (II)

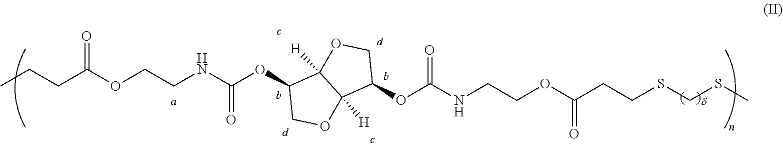

and any derivatives thereof. In yet another embodiment, the polymer as provided herein comprises a homopolymer having subunits comprising polyurethane-containing isodide (IIPU) having the general formula (III)

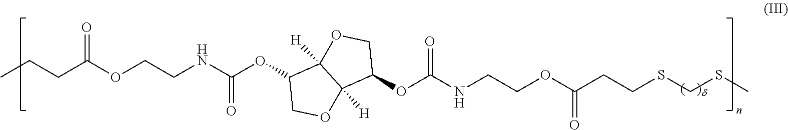

and derivatives thereof.

One key finding by the inventors was, based on the disparity of mechanical properties of some of the homopolymers (e.g., IIPU, IMPU, etc.), the ability to finely manipulate material mechanical properties over a wide range by combining the homopolymers to create copolymers having controlled stereochemical composition. These copolymers were obtained by varying the relative quantity of monomers (e.g., isoidide monomers, isomannide monomers, etc.) in the feed and copolymerizing them with a dithiol (e.g., 1,8-octanedithiol, etc.) to create a copolymer. These resulting copolymers were shown to behave like tough plastic by having increased tensile strength and toughness as compared to non-copolymers and without imparting crystallinity.

Accordingly, another aspect of the present disclosure provides for a copolymer having one or more different polymer subunits joined together. In one embodiment, the copolymer comprises one or more subunits selected from the group consisting of: isosorbide polyurethane (ISPU) having the general formula (I)

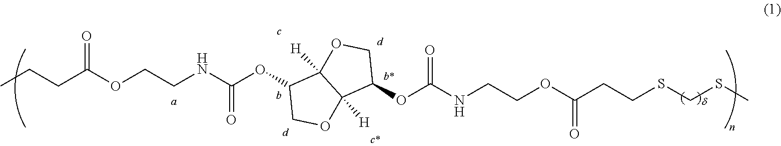

and any derivatives thereof; isomannide polyurethane (IMPU) having the general formula (II)

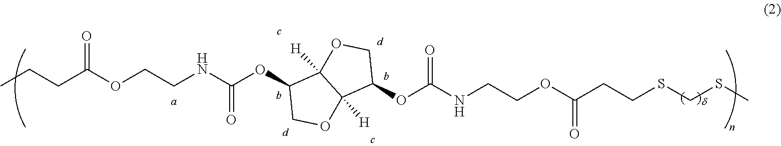

and any derivatives thereof, and polyurethane-containing isodide (IIPU) having the general formula (I1)

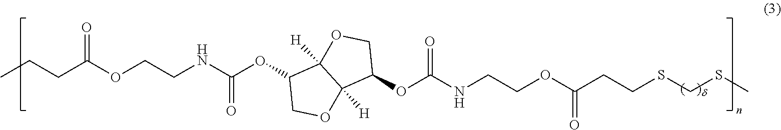

and derivatives thereof.

In some embodiments, the copolymer comprises a blend of isodide (II) and isomannide (IM). In one embodiment, the copolymer comprises a blend of isodide (II) and isomannide (IM) at a ratio of 75:25 (co-II₇₅IM₂₅). In another embodiment, the copolymer comprises a blend of isodide (II) and isomannide (IM) at a ratio of 25:75 (co-II₂₅IM₇₅). In yet another embodiment, the copolymer comprises a blend of isodide (II) and isomannide (IM) at a ratio of 50:50 (co-II₅₀IM₅₀).

The polymers and co-polymers provided herein have many uses and may take many physical forms, such as an article or a film. Hence, another aspect of the present disclosure provides an article and/or film comprising, consisting of, or consisting essentially of a plurality of biodegradable thermoplastic polyurethane (TPU) polymers as provided herein. In some embodiments, the article and/or comprises a polymer having a plurality of hard segments, each hard segment separated by a rigid 1,4:3,6-dianhydrohexitol molecule.

As described above, a preferred embodiment comprises the use of copolymers due to their enhanced strength and mechanical performance. Thus, another embodiment of the present disclosure provides for an article and/or film having a plurality of biodegradable thermoplastic polyurethane (TPU) copolymers as provided herein.

Another key feature of the present disclosure provides for the physical blending of one or more different polymers and/or copolymers as provided herein in, for example, an article and/or film.

Such blends may comprise one or more different homopolymers and/or copolymers as provided herein to form an article and/or film according to the present disclosure. The exact ratio of the one or more homopolymer and/or copolymers are dependent on the desired characteristics of the article and/or film to be made and can be determined by one skilled in the art. In another embodiment, the article comprises a physical blend of two or more different biodegradable thermoplastic polyurethane (TPU) copolymers as provided herein.

The present disclosure further provides methods of making the polymers as provided herein.

Hence, another aspect of the present disclosure provides a method of making a biodegradable thermoplastic polyurethane (TPU) polymer as provided herein, the method comprising, consisting of, or consisting essentially of reacting an (a) acrylate-terminated monomer comprising, consisting of, or consisting essentially of: (i) at least one dianhydrohexitole and (ii) at least one urethane group; (b) a thiol; and (c) a catalytic quantity of an alkylphosphine in a base-mediated thiol-ene addition polymerization process.

In one embodiment, the thiol is selected from the group consisting of a linear dithiol, a branched tri-thiol, and a branched tetra-thiol.

Another aspect of the present disclosure provides all that is described and illustrated herein.

The following Examples are provided byway of illustration and not by way of limitation.

It will be understood that all test procedures and physical parameters described herein have been determined at atmospheric pressure and room temperature (i.e. about 20° C.), unless otherwise stated herein, or unless otherwise stated in the referenced test methods and procedures. All parts and percentages are given by weight unless otherwise stated.

### EXAMPLES

1. Stereochemically-Driven Mechanical Properties in Sugar-Based Degradable Polymers

A. Abstract/Introduction

Commercial plastics are robust, lightweight materials that have become crucial to societal needs. Our use and disposal of them is however, making their environmental detriment increasingly evident. Replacing non-degradable petrochemically-derived commercial plastics with sustainable (biodegradable) substitutes remains challenging as non-degradable plastics usually possess superior thermomechanical properties. We report that subtle stereochemical differences in isohexide-based polyurethanes can result in distinct intra- and inter-chain supramolecular interactions that dominate the resulting bulk properties, affording degradable materials with thermomechanical properties that exceed most commodity plastics and rubbers. In contrast to the isomannide-based polymer, which is a strong (high UTS) amorphous elastomer, the isoidide-based homopolymer is a robust, semi-crystalline thermoplastic with higher toughness (320 MJ m−3) than HDPE or nylon-6. Significantly, the thermoplastic nature of these materials enables them to be recycled mechanically by reprocessing, while the chemical structure allows for hydrolytic degradation to occur in a structure-controlled manner. Importantly, as a consequence of the isomeric relationship between isoidide and isomannide, we were also able to show that blended copolymer formulations enable decoupling of the material properties and degradation behavior. Computational evidence supports the contradictory material properties between the isomeric polymers by correlating intra- and inter-chain hydrogen bonding interactions to stereochemistry of the isohexide unit to suggest that the supramolecular interactions are driven by the stereochemically-defined interface to dominate the observed mechanical properties.

Herein, a degradable isoidide-based polyurethane is reported. In contrast to what may be expected by varying stereochemistry in polymers such as PP or PLA, the isoidide-based materials display plastic behavior, a sharp contrast to the isosorbide and isomannide-based materials that are elastomeric in nature. Moreover, the isoidide-based plastics possess excellent thermoplastic properties including outstanding toughness, resulting from its semi-crystallinity and low glass transition temperature, that surpasses many leading plastics such as nylon 6 and high-density polyethylene (HDPE). Notably, comparison of the stereochemical impacts between isoidide- and isomannide-containing materials indicates an unparalleled difference in their respective mechanical properties. Computational investigations offer guidance to explain this contradictory performance between the isomeric polymers by demonstrating that the stereochemistry of the isohexide unit defines the supramolecular interactions within the material that in turn defines the mechanical properties. These differences were further exploited by copolymerizing stereoisomers and physically blending homopolymers to tune hydrolytic degradability and thermomechanical properties independently of one another.

B. Results

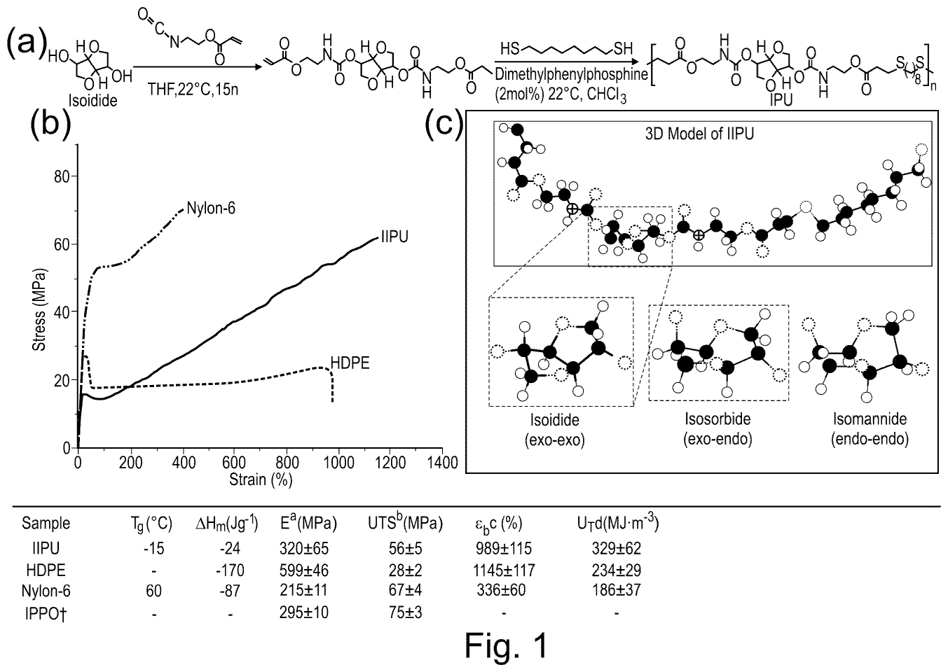

Synthesis of a polyurethane-containing isoidide (IIPU) in the main chain was achieved using an efficient two-step protocol that simplifies a previous protocol (FIG. 1a). The reaction of isoidide with commercially available 2-isocyantoethylacrylate yielded a diacrylate-terminated monomer featuring internal urethane units which was reasoned would enhance polymer properties by promoting a strong hydrogen bonding network and complementing the rigidity of the isohexide unit. The monomer was reacted with 1,8-octanedithiol using a phosphine-catalyzed thiol-Michael polyaddition under mild conditions (ambient atmosphere and temperature) to furnish a high molecular weight white, fibrous material (Mw=96 kDa, Ð=8.12).

The isolated polymer sample possessed high thermal stability (See Example 3: Supplementary Information) that enabled facile processing (heated compression molding) into a flexible, free-standing film suitable for mechanical analysis. It was observed that the fabricated films became less transparent (indicative of crystallization) within hours of processing so the films were annealed for three days before testing to ensure a thermal equilibrium had been reached. The mechanical properties of the annealed IIPU sample were assessed using uniaxial tensile testing and compared with commodity polymer samples—Nylon-6, HDPE, and LDPE-that were also tested under the same conditions (FIG. 1b). IIPU possessed a high Young's modulus (320±65 MPa) and a clear yielding point when the material entered the plastic deformation region, which is a general feature to most thermoplastic materials. The stiffness and ductility of IIPU was comparable to common plastics such as LDPE and HDPE, however the strain hardening phenomenon exhibited in IIPU (near ˜100% strain) resulted in a substantially larger ultimate tensile strength (UTS). In fact, the UTS of IIPU is analogous to high performance engineering plastics such as nylon-6. IIPU is a remarkably tough thermoplastic that merges the ductility of polyolefins with the strength of nylons and classes it, not just similar to, but superior to commodity plastics. These observations highlight the massive potential of isoidide as a bio-derived building block in polymer materials.

The stark contrast in mechanical behavior displayed by IIPU to its structural analogues derived from isosorbide (ISPU) and isomannide (IMPU) inspired us to determine the influence of stereochemistry on material properties. The unique bowl-shaped structure that results in isosorbide from two fused tetrahydrofuranyl rings with stereo-divergent hydroxyl groups (one exo, one endo relative to the plane through the rings) typically leads to regio-irregular polymer backbones (endo-endo versus endo-exo versus exo-exo connectivities) due to non-selective reactivity. While this can be overcome by regio-controlled ring-opening polymerization or using unsymmetrical isosorbide A-B monomers, polymers were compared with more analogous chemistry and hence focused the study on the isomannide (endo-endo) derivative to eliminate the effects of regiochemistry that are associated with the isosorbide derivative from our study. An isomannide-polyurethane (IMPU) was prepared in an analogous protocol to IIPU synthesis to afford an optically transparent and rubbery material with comparable molecular weight and dispersity (Mw=117 kDa, Ð=8.12). It was striking to observe that IMPU was optically transparent and rubbery in nature.

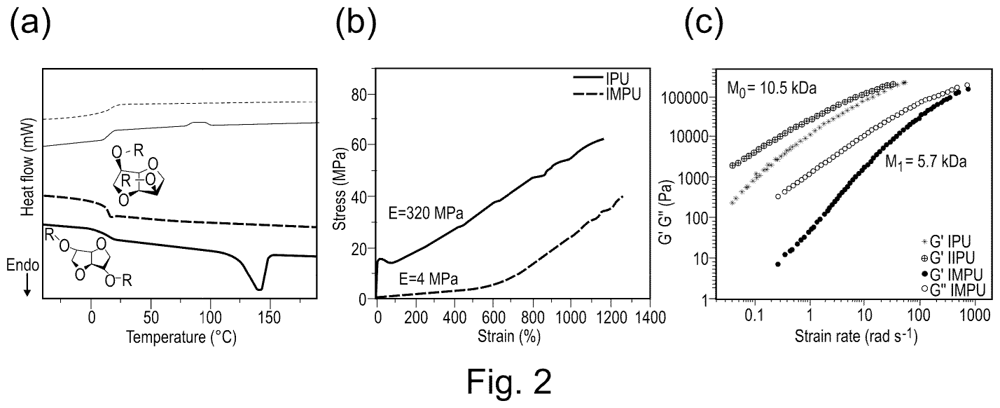

Even though it was envisioned that the configurational differences between the isohexide diastereomers would affect the polymer chain packing, and consequently the crystallinity, to influence the bulk thermomechanical properties of the polymer, the obvious qualitative difference between the two polymers was still surprising. Annealed thin films of IIPU and IMPU were compared using differential scanning calorimetry (FIG. 2a). Despite IIPU and IMPU possessing similar glass transition temperatures (Tg˜15° C.), the DSC thermogram indicates a distinct difference at higher temperatures. The sharp endothermic peak (140° C.) observed in the IIPU heating run is characteristic of a first-order phase transition (Tₘ) but is absent in IMPU. This suggests that IIPU is semi-crystalline and IMPU appears to be amorphous. To further understand how the isohexide structure influenced the polymer chain interactions, rheological frequency sweeps were performed on IIPU and IMPU at various temperatures (FIG. 2c). From this measurement, molecular weight between polymer entanglements (Me) can be calculated from the plateau modulus. IIPU was calculated to have a larger Me (Me=10.5 kDa, Ge=1.8 MPa) than IMPU (Me=5.7 kDa, Ge=5.3 MPa), which indicates that the isohexide stereochemistry impacts chain entanglements.

For both IIPU and IMPU, tensile testing showed significant strain hardening leading to high UTS and toughness, but these materials also displayed unprecedented mechanical differences as evidenced by their respective stress-strain profiles (FIG. 2b). The tough plastic behavior of IIPU was starkly contrasted against the soft elastomeric behavior of IMPU, underlined by an almost two orders of magnitude difference in Young's moduli (IIPU E=320, IMPU E=4 MPa). In addition, IMPU displayed excellent recoverability after deformation evidenced by the absence of a yielding point in the tensile curve, whereas the IIPU was irreversibly deformed above the yield point.

Creating materials with mechanical properties that are this divergent usually requires significant microstructure changes to the polymer architecture (such as altering composition, topology and/or cross-linking), i.e. one must ‘redesign’ the polymer. Here, the profound discrepancy in thermomechanical properties appears to be solely attributed to the seemingly minor stereochemical differences between the isohexide moieties.

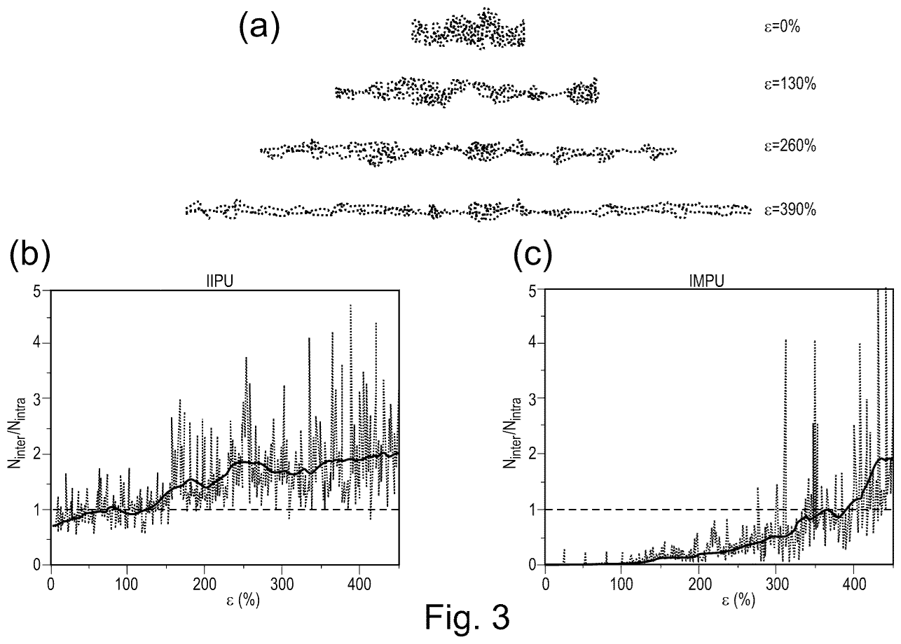

Detailed molecular dynamics simulations were performed to highlight the origin of the unique mechanical properties of the IIPU polymer. Evolution of the macromolecular conformations of two intertwined IIPU macromolecules upon deformations are illustrated in snapshots (FIG. 3a). The effect of the macromolecular elongation on intermolecular interactions is quantified which demonstrates striking differences between structural transformations in IIPU and IMPU (FIGS. 3b and 3c). Specifically, the IIPU macromolecules have a larger number of both inter- and intra-molecular H-bonds in the undeformed state in comparison with those observed for IMPU systems.

In fact, an almost equal number is indicated by the observed ratio close to unity. With increasing deformation, the number of intramolecular H-bonds decreases for both systems while the number of inter-molecular bonds remains constant for IIPU system and increases for IMPU polymers. This preference for formation of the intermolecular associations for IIPU macromolecules could be a reason for favoring crystallization of these polymers upon cooling.

The disparity of mechanical properties between IIPU and IMPU presented the opportunity to finely manipulate material mechanical properties over a wide range by combining the stereoisomers.

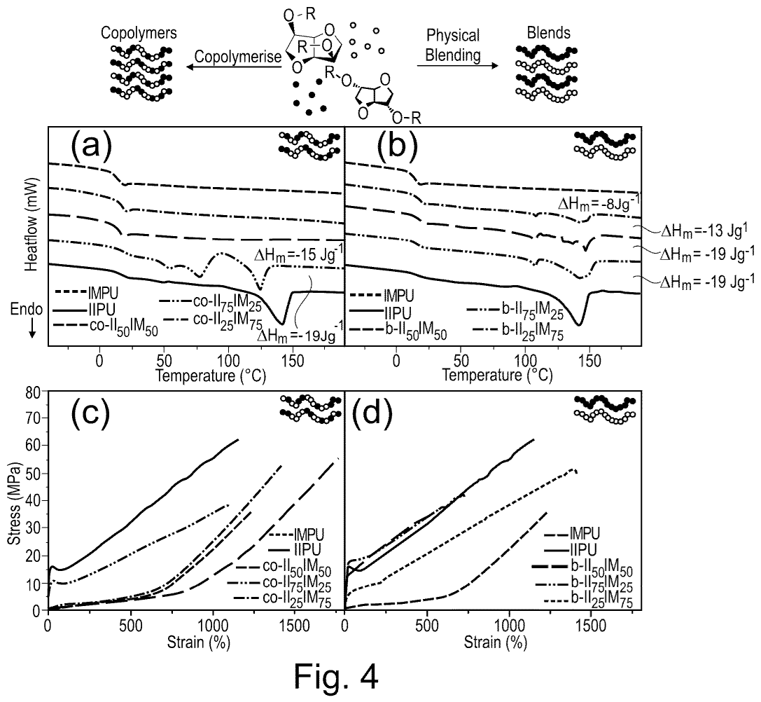

Random copolymers (II-co-IM-PU) with controlled stereochemical composition were obtained by varying the relative quantity of isoidide and isomannide monomer in the feed and copolymerizing with 1,8-octanedithiol to afford polymers suitable for DSC and tensile testing (FIGS. 4a and 4c).

The copolymer thermal properties seemed to be more influenced by isomannide rather than isoidide by disrupting crystallization. Although co-II₇₅IM₂₅ (75% isoidide content) was still semi-crystalline, there was a noticeable reduction in overall crystallinity evidenced by a decrease of 4 Jg⁻¹ in the total enthalpy of melting (ΔHm), compared to IIPU, and a decrease in the overall Tₘ (A17° C.). Below 75% isoidide content, the polymers were amorphous with no definable first-order transitions observed in DSC thermograms (FIG. 4A). These differences in crystallinity are reflected in the respective tensile properties for each copolymer. The semi-crystalline co-II₇₅IM₂₅ behaved like a tough plastic, which demonstrated a reduction in material toughness and modulus as compared to IIPU. Likewise, both co-II₅₀IM₅₀ and co-II₂₅IM₇₅ presented with a similar tensile profile (J-shaped curve) to the elastomeric IMPU. Importantly, these polymers also feature a notable increase in strength and toughness compared to IMPU suggesting that the presence of isoidide enhanced the mechanical performance of co-II₅₀IM₅₀ and co-II₂₅IM₇₅ without imparting crystallinity that is observed in the stereopure IIPU or 75% II formulation. This feature also adds to the capacity of isoidide as an attractive sustainable comonomer.

Despite their distinctly different mechanical properties, the structural similarities between IIPU and IMPU enable physical blending to afford the fabrication of homogeneous films. Polymer blends with varying quantities of IMPU and IIPU were made by a simple dissolution-precipitation and then melt processed into uniform films after drying. Notably, the physical blends display multifeatured DSC profiles (FIG. 4b). In contrast to the copolymer samples, all physical blends were semi-crystalline but they exhibited more complex melting behaviors compared to IIPU. Nevertheless, these melting events occurred over similar temperature ranges as the phase transitions in IIPU, which alludes that IIPU crystallization is uninhibited by physical dilution with IMPU. Surprisingly, the ΔHm for the blended films is greater than expected when normalized to the molar content of isoidide in the sample (See Example 3: Supplementary Information). The presence of IMPU homopolymer actually enhances the crystallization efficiency of IIPU, which is a similar phenomenon previously reported in cis- or trans-rich poly(isoprene) blends.

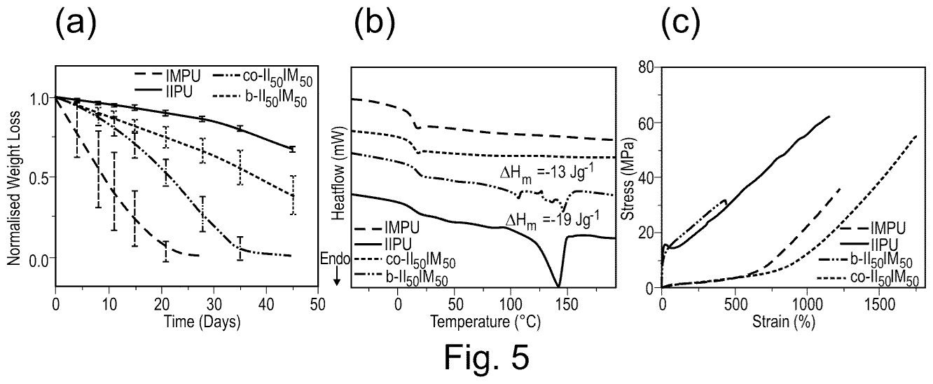

In addition to the exceptional mechanical capabilities of the isohexide-based platform, a demonstration of tuneable degradability was also a key target for this study. A straightforward accelerated degradation experiment using 1 M NaOH was performed on thin discs (ca. 0.5 mm thickness) of IIPU, IMPU, co-II₅₀IM₅₀ and b-II₅₀IM₅₀ to assess the influence of stereochemistry and composition on the hydrolytic degradation (FIG. 5A). It was predicted that the polymer degradation behavior would be largely regulated by crystallinity since the overall composition was similar among all samples, i.e. only two isomeric monomers were employed. Polymer crystallinity is known to inhibit hydrolytic degradation by restricting water penetration into the bulk sample, a persistent issue encumbering the ‘real-world’ degradability of many semi-crystalline polyesters such as polylactic acid, polycaprolactone or poly(6-decalactone) in the environment. Although IIPU degraded at a slower rate than amorphous IMPU, the sample still exhibited significant bulk mass loss within the timeframe of the study (˜25% mass loss within 45 d) despite the high crystallinity which can be rationalized by the existence of three hydrolysable species—urethane, ester and isoidide—within the polymer backbone. Furthermore, the impressive hydrolytic susceptibility of IMPU (complete deterioration within 30 d under the accelerated conditions used) ranks it as a reprocessable degradable elastomer due to its un-crosslinked topology and good thermal resistance. These qualities alone make IMPU exceptional among known synthetic elastomers.

In the efforts to tune degradation profiles, the crystalline polymer blend (b-II₅₀IM₅₀) and the analogous amorphous copolymer (co-II₅₀IM₅₀) under the same conditions was explored. Surprisingly, the b-II₅₀IM₅₀ degraded far more rapidly than IIPU, even though thermomechanical properties are relatively comparable, which points to IMPU content as a means to modulate the rate of hydrolytic degradation in the blends (FIG. 5a). On the contrary, co-II₅₀IM₅₀ degraded significantly slower than the IMPU despite both materials being amorphous and possessing similar T_{g}s. Again, this indicates that the isoidide moiety could also influence the bulk polymer properties without significantly altering the crystallinity or tensile properties. Looking at this from a different perspective, it was possible to tune mechanical properties independent of degradation as well since both IIPU and co-II₅₀IM₅₀ showed similar degradation profiles but tremendously different tensile behavior (plastic vs elastic). By simply incorporating either isommanide or isoidide (i.e. changing only stereochemistry) into varied formulations, it was feasible to independently adjust bulk material properties. The only examples of matching degradability control in synthetic polymers come from studies on sequenced degradable polyesters, however impact and relation to bulk tensile properties was not investigated for these materials.

C. Conclusions

The optimization of robust non-degradable plastics has been refined and perfected over decades, but ultimately, they still lack any tolerable environmental degradation with mounting negative impacts. Developing degradable plastics from sustainable sources that can mechanically compete with petrol plastics is a monumental task. The complex structure and intricate stereoisomerism found in natural compounds provides a strategic advantage in the endeavor towards mechanically competitive materials. The unprecedented differences between isoidide and isommanide-based materials, as well as their outstanding mechanical features in their own right, is testament to the potential of leveraging stereochemistry to influence supramolecular interactions (especially ring-induced geometric isomerism) in bio-sourced monomer feedstocks. However, the most outstanding feature of this system is the ability to independently tune, or decouple, the hydrolytic degradation rate from the thermomechanical properties while also simultaneously controlling these features.

Simply put, the exhibition of intricate property manipulation presented herein is unparalleled in the existing materials portfolio. Furthermore, this study affords a path to materials with on-demand property tuning and independently controllable degradation rates that is made possible only by stereochemical manipulation. Looking ahead, the effect of combining stereochemical considerations with other microstructure feature control (such as sequence or topology) should yield sustainable materials with even more advanced properties and functionality, i.e. providing a ‘disruptive technology’ to transform the current plastics economy.

2. Remarkably Tough, Reprocessable Elastomers Derived from Isohexide Monomer Stereochemistry and Hydrogen Bonding

A. Abstract

The remarkable mechanical properties of elastomers found in nature are characterized by high elasticity and tensile strength that are difficult to mimic using synthetic methods. Traditional synthetic strategies to reproduce these properties focus primarily on the use of chemically crosslinked networks, hydrogen bonding or increasing the content of crystalline domains. While useful, these strategies have significant drawbacks including limited end-of-life options, reduced optical clarity upon deformation, and a tradeoff between strength and extensibility. It is reported herein that the synthesis of thermoplastic polyurethane (TPU) elastomers containing renewably sourced 1,4:3,6-dianhydrohexitols stereoisomers that display exceptional strength and elongation at break, superior to both natural and synthetic commercial rubbers and thermoplastic elastomers. The unique combination of the rigid ring structures adjacent to distinct and strong hydrogen bonding interfaces imparted by the stereochemical configuration are shown to impart unique material properties including strain rate dependent behavior, significant strain hardening, and high optical clarity that is retained throughout elongation. These phenomena are attributed to dynamic transitions between intra- and inter-molecular hydrogen bonding in the transient crosslinking network, as revealed by computational and experimental investigations. In addition to the renewably sourced feedstock, the self-organization of the stereochemically-defined sugar units and high thermal stability of these materials facilitate facile reprocessing with minimal loss of mechanical performance, making them excellent candidates for sustainable alternatives to commodity elastomers.

B. Introduction

Elastomers have become ubiquitous throughout society since Charles Goodyear first described the vulcanization of natural rubber in 1844. Owing to their high fracture strength, toughness, and extensibility, elastomers have found widespread utility in the automotive industry, healthcare, coatings, and robotics. Recent years have simultaneously witnessed both an increased demand for tough, high modulus materials, and an urgent call to mitigate the extreme environmental impacts of polymer consumption. Developing commercially relevant sustainable elastomers has proven to be particularly challenging because most elastomers are derived from nonrenewable petrochemical feedstock and have limited degradation on reasonable time scales. However, developing “sustainable” alternatives to both natural and synthetic rubbers is particularly challenging because traditional strategies to increase mechanical strength involve a concomitant increase in the crosslink density of the material. Chemical crosslinks impart solvent resistance, high thermal stability and toughness, but they severely limit end-of-life options. Thermoplastic elastomers (TPEs), on the other hand, derive their elasticity from physically crosslinked networks, including crystalline domains and hydrogen bonding, which allow these materials to be reprocessed at elevated temperatures, reducing their environmental impact. However, strength and elasticity properties possess a competitive tradeoff in traditional elastomer systems; thus, increasing the crosslinking density improves material strength but reduces extensibility.

One novel approach for minimizing the tradeoff between strength and extensibility in TPEs is to incorporate dynamic, reversible crosslinks into the materials. Hydrogen bonding, metal coordination chemistry, ionic and coulombic interactions, and supramolecular chemistry have each been incorporated into elastomeric systems as both primary networks and as sacrificial networks in conjunction with traditional crosslinks. Previous studies have shown that the dynamic rupture and reformation of the reversible bonds releases residual stress. This release allows for localized relaxation of network strands which minimizes stress concentrations and promotes effective energy dissipation, simultaneously enhancing both the strength and elasticity of the material. Materials that incorporate these types of transient network structures have exhibited several interesting and unexpected properties including hyper-elasticity, strain-dependent properties, self-healing ability, and high optical clarity. In the absence of a traditionally crosslinked network, the mechanical performance is dependent on the “effective crosslink density” of the material. On time scales shorter than the association time of the reversible bonds, the dynamic crosslinks act as a strong network and the material is elastic. Conversely, viscoelastic properties are observed on longer time scales or at elevated temperatures, which allow for continuous dissociation and reassociation of crosslinks.

Herein, it is reported that the synthesis of 1,4:3,6-dianhydrohexitol based polyurethane elastomers, which derive their unprecedented mechanical properties from a transient hydrogen bonding network derived from the distinct stereoisomers. Polyurethanes are a versatile class of polymers that utilize interplay between hard blocks and soft blocks to access diverse material properties. Synthesized by using thiol-ene addition chemistry, the polyurethanes presented herein have high molecular masses and alternating sequences instead of the traditional block structures. Additionally, the urethane groups in each “hard segment” are separated by a rigid 1,4:3,6-dianhydrohexitol molecule. 1,4:3,6-dianhydrohexitols are non-toxic, small molecules derived from polysaccharides that have recently proven to be a renewable feedstock alternative to petroleum derivatives for commercial polymer production. These molecules consist of two, fused cis-shaped tetrahydrofuran rings with two hydroxyl groups. 1,4:3,6-dianhydrohexitols are chiral molecules that exist in three isomeric forms: isosorbide (1,4:3,6-dianhydro-D-glucitol), isomannide (1,4:3,6-dianhydro-D-mannitol), and isoidide (1,4:3,6-dianhydro-L-idotol). These stereoisomers differ in the position of their hydroxyl groups, with groups in the endo-position exhibiting reduced chemical reactivity as a consequence of steric hinderance and hydrogen bonding with ether groups in the ring system. As one of the top 20 biomass sourced molecules, isosorbide has been the most thoroughly investigated. Polymers containing isosorbide units have been shown to have high glass transition temperatures (Tg), a consequence of the rigid structure, excellent durability, and high optical clarity. As such, Mitsubishi has produced an isosorbide-based polycarbonate which is used in the front panels of smartphones. Therefore, both isosorbide and isomannide are reported in this work so that the effect of stereochemistry on network dynamics and mechanical performance could be investigated.

Specifically, we demonstrate that the combination of urethane and isohexide groups physically crosslink the polyurethanes with a dynamic hydrogen bonding network that imparts outstanding strength, toughness, extensibility, and high optical clarity. As the materials are deformed, these networks undergo a cascading sequence of events that results in significant hardening at high strain, without loss of transparency or other evidence of strain-induced crystallization. It is also shown that these amorphous thermoplastics exhibit good thermal stability and thus can be readily reprocessed without significant degradation or diminishing mechanical performance.

C. Results and Discussion

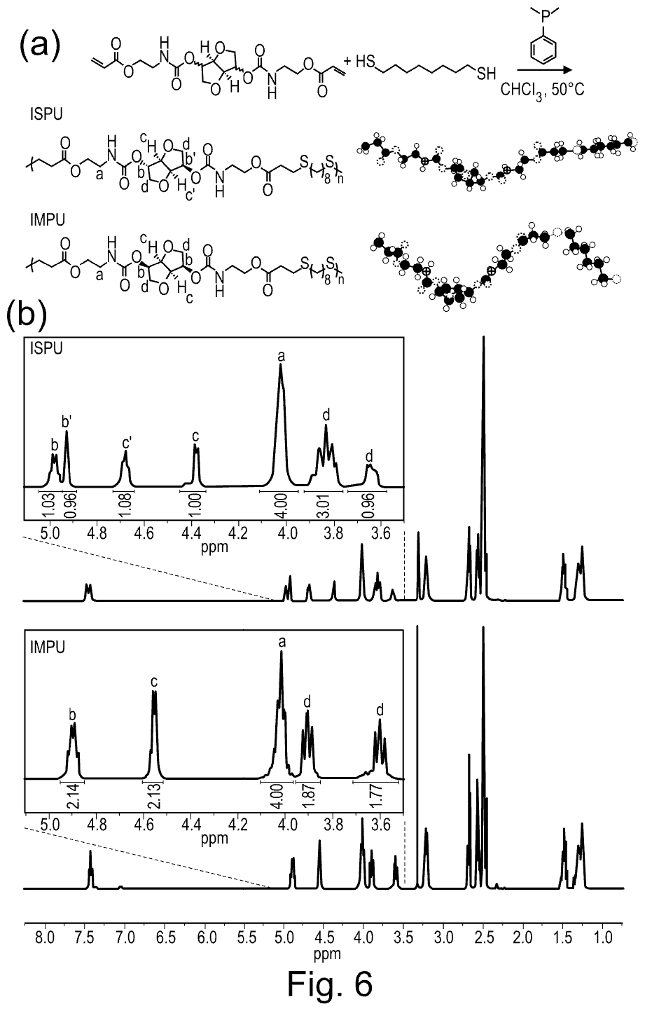

Isosorbide and isomannide containing polyurethanes were synthesized via a phosphine-mediated thiol-ene addition polymerization. In this reaction, an acrylate-terminated monomer containing either isosorbide or isomannide and urethane groups was added to 1,8-octanedithiol with a catalytic quantity of dimethylphenyl phosphine and stirred for 16 hours at room temperature (FIG. 6A).

This efficient synthesis yields isosorbide polyurethane (ISPU) and isomannide polyurethane (IMPU), high molecular weight (Mw=109.5 kDa and Mw=56.5 kDa respectively) copolymers with alternating sequences. Economically and environmentally, it is advantageous that this polymerization yields high MW polymers under ambient conditions without needing to heat the reaction. Additionally, the size, architecture and number of reactive chain ends of the thiols can be modified easily to precisely control the architecture of the H-bonding network.

The isolated polymers were readily processable by compression into transparent, thin films at 120° C. and were thermally stable (Td onset>300° C.). Interestingly, thermal degradation of the urethane chains occurred before the sugar moiety, as confirmed by thermogravimetric analysis (TGA), indicating that the inclusion of a renewable sugar backbone in the materials did not compromise their thermal stability. Differential scanning calorimetry (DSC) analysis of both ISPU and IMPU showed that they were completely amorphous, with glass transition temperatures (Tg) below 25° C. Thus, both were anticipated to be flexible at room temperature and above. It should be noted that both materials exhibit a single Tg, indicating that the materials are not phase separated. It has been suggested that this sort of homogeneity can be beneficial, because hard and soft domains have a mutually completive dependence on chain mobility.

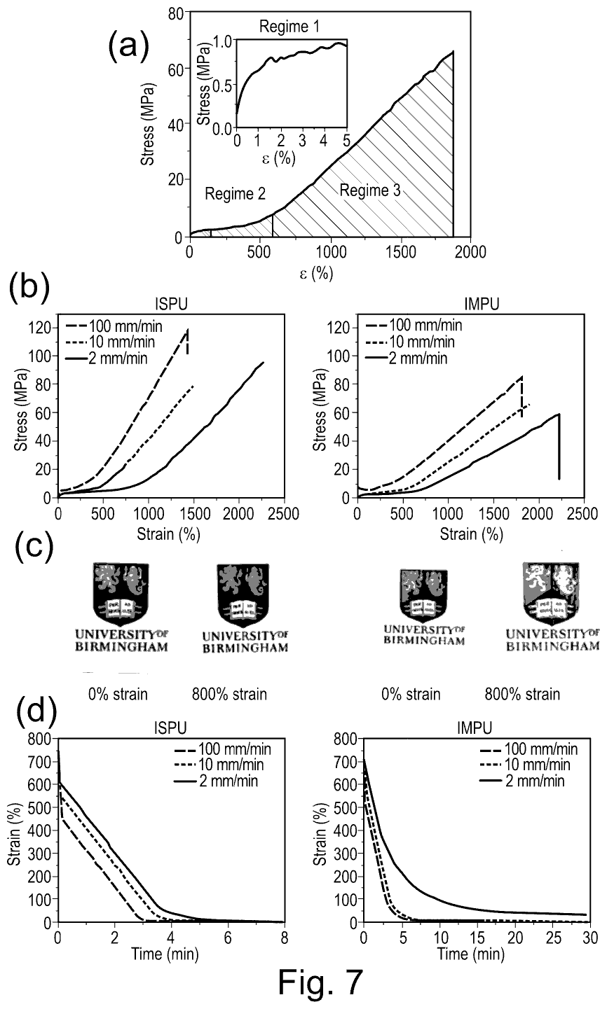

ISPU and IMPU were uniaxially strained at a strain of 10 mm/min to initially assess their mechanical properties. This revealed that both materials were tough elastomers that exhibited unprecedented tensile strength and extensibility at failure. ISPU was slightly stronger, with and average stress at break of 75.1 MPa, compared to 63.5 MPa in IMPU. Conversely, IMPU had a higher strain at break than ISPU, with the materials breaking at 1806% and 1466% strain, respectively. Interestingly, both materials exhibited unique, strain-dependent mechanical responses to deformation that resulted in “J-shaped” stress-strain curves with three distinct elastic regimes which is summarized in FIG. 7A.

The first regime is characterized by a rapid, linear increase of stress at low strains (ε<0.05). In the second regime (approximately 0.05<ε<5.0), the stress continues to increase with increasing strain, but the rate of increase is significantly slowed compared to the other regimes. Strain hardening occurs in the third regime (ε>5.0) as the rate of stress accumulation increases again. Rheological analysis confirmed that both materials were well above the MW needed for chain entanglement (the complete details are included in supplementary information), the variations in mechanical performance can be attributed to stereochemical differences in the 1,4:3,6-dianhydrohexitol units of ISPU and IMPU. However, the unique strain dependence observed in both materials suggests that they undergo similar network dynamics during deformation.

To further investigate the H-bonding network dynamics, mechanical testing was conducted as a function of strain rate. Similar to previous results reported for elastomers containing H-bonding networks, ISPU and IMPU samples strained quickly (100 mm/min) had the highest stress at break and the highest modulus in each regime. This occurs because the relative time scale of deformation is shorter than the lifetime of the transient network, thus the H-bonds act as strong crosslinks and the elastic character of the material dominates. Alternatively, when samples are strained slowly, dynamic rearrangement of the transient crosslinks can occur which enhances the viscous characteristics of the material. When strained at 2 mm/min, ISPU and IMPU exhibited higher strains at break and a slower accumulation of stress than materials stretched more quickly. Notably, slow deformation speeds did little to diminish the extent of strain hardening, but rather delayed its onset. As such, both materials were actually tougher when strained at 2 mm/min than at 10 mm/min. This was particularly significant in ISPU, where the samples strained at 2 mm/min had higher stress at break, strain at break, and toughness than those deformed at 10 mm/min.

TABLE 1
Mechanical characterization of isosorbide and isomannide polyurethanes

| | Strain | | | | | | |
|---|---|---|---|---|---|---|---|
| | Rate | Strain at | Stress at | E₁ | E₂ | E₃ | U_{T} |
| Polymer | (mm/min) | Break (%)^{a} | Break (MPa)^{a} | (MPa)^{b} | (kPa)^{b} | (kPa)^{b} | (MJ/m³)^{c} |
| ISPU | 2 | 1980 ± 234 | 86.2 ± 8.4 | 3.5 ± 0.7 | 0.6 ± 0.1 | 7.1 ± 0.6 | 555.2 ± 100.3 |
| | 10 | 1466 ± 81 | 75.1 ± 3.6 | 7.5 ± 0.4 | 1.0 ± 0.1 | 7.2 ± 0.4 | 407.3 ± 27.9 |
| | 100 | 1358 ± 67 | 117.4 ± 11.4 | 48.0 ± 3.7 | 2.2 ± 0.2 | 10.0 ± 0.6 | 567.8 ± 76.0 |
| IMPU | 2 | 2188 ± 32 | 54.7 ± 6.4 | 13.8 ± 1.2 | 0.6 ± 0.1 | 3.5 ± 0.3 | 449.0 ± 38.4 |
| | 10 | 1806 ± 69 | 63.5 ± 2.3 | 44.2 ± 7.8 | 0.9 ± 0.1 | 4.7 ± 0.1 | 445.7 ± 38.6 |
| | 100 | 1814 ± 19 | 81.6 ± 3.3 | 84.3 ± 9.5 | 1.2 ± 0.2 | 5.3 ± 0.1 | 648.0 ± 25.0 |

^{a}Determined by uniaxial deformation of tensile bar until failure (22° C., n = 3, annealed at 25° C. for 7 d after pressing).
^{b}Modulus in each regime during deformation. Determined by slope the slope of the stress-strain curve in a linear segment of each regime (22° C., n = 3, annealed at 25° C. for 7 d after pressing).
^{c}Determined by integration of the area under the stress-strain curve obtained during uniaxial deformation (22° C., n = 3, annealed at 25° C. for 7 d after pressing).

It has previously been reported that elastomers based on reversible, coordination systems undergo unique, time-dependent recovery from deformation. This is a consequence of competition between thermodynamics favoring return to an equilibrium state and the temporary reformation of bonds in the transient network. This has been shown to result in a rapid initial recovery that slows as bonds are reformed. Thus, the elastic recoveries of ISPU and IMPU were monitored as a function of stress versus time. In this experiment samples were stretched to 750% strain at different rates and allowed to recover without a predetermined rate by maintaining zero force. Elastic recovery was affected by both the rate of deformation and the stereochemistry of the 1,4:3,6-dianhydrohexitol unit in the polymer backbone. Overall, IMPU recovered slower than ISPU, particularly in the last stage of recovery. When deformed at 2 mm/min, IMPU did not recover fully at all. However, it was qualitatively observed that heating the deformed IMPU sample enabled complete recovery. Previous studies have reported this phenomenon in similar systems and attribute the full recovery to the disruption of the reformed bonding network at elevated temperatures.

One of the most interesting features of ISPU and IMPU is the strain hardening observed at high strains. It is an advantageous feature in elastomers because it dramatically increases the stress needed to rupture bonds, which slows crack propagation and improves performance. This phenomenon is observed in natural tissues, but is most commonly associated with natural rubber. In natural rubber, strain hardening is a consequence of strain-induced crystallization. During tensile testing it was observed that ISPU and IMPU remain transparent at high strain, suggesting that the hardening observed in these materials is not a consequence of strain induced crystallization, as this would change the opacity of the material. To experimentally quantify this observation, a simple experiment was designed in which a white light source was passed through the material during deformation, and the intensity of the transmitted light was recorded using a spectrophotometer positioned behind the sample. When the material was subjected to tensile stress, only a slight decrease in light intensity was observed across a range from 200% to 800% strain (See Example 3: Figure S25). This was compared to high-density polyethylene (HDPE), a conventional synthetic material that is well-known to undergo strain-induced crystallization. In this case, a substantial decrease in optical transparency was observed as the sample was stretched to 600% strain.

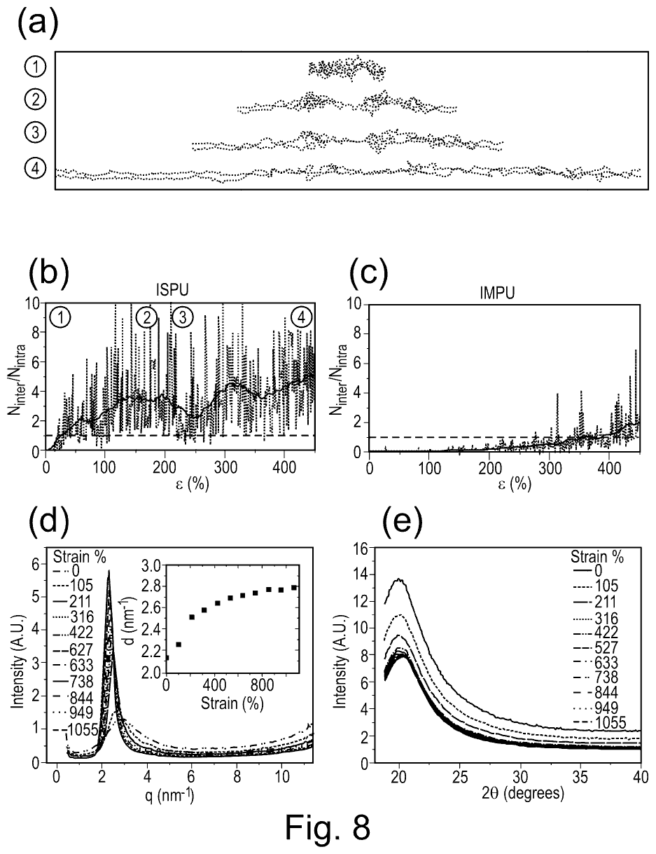

To elucidate the mechanisms behind the unique mechanical properties of these materials, we have performed all atomistic molecular dynamics simulations of ISPU and IMPU chains (see Example 3: Supplemental Information for details). FIG. 8A panel a shows snapshot of two chains in their initial relaxed conformations. With increasing deformation chain backbone alignment increases (FIG. 8A panels b-d). Therefore, to accommodate such conformational changes and to release a local chain stress the transient network of H-bonds is transformed as well. In particular, we observed destruction of the intrachain H-bonds and formation of the interchain ones (FIGS. 8B and 8C).

Note that such H-bond rearrangement also provides dissipation channel for deformation energy. Comparison of H-bond evolution between ISPU and IMPU chains is shown in FIGS. 8B and 8C. Both materials showed a transition from intra- to inter-chain H-bonding dynamics during elongation. However, the rate of this transition varied with the stereochemistry of the materials. ISPU showed a rapid transition from intramolecular to intermolecular bonding in the initial stages of deformation. After this initial transition, the relative ratio of these bonds plateaued until intramolecular bonding was eliminated entirely at high strain. Alternatively, IMPU experienced a slow loss of intramolecular bonding that corresponded with a similar increase in the number of intermolecular bonds.

To further confirm this result, ISPU was analyzed using small angle X-ray scattering (SAXS) and dynamic wide-angle X-ray scattering (WAXS). There were notable changes in the SAXS profile of ISPU during deformation (FIG. 8D). The WAXS data show that, at 0% strain, ISPU possesses a broad signal at small scattering angles (2θ<30°), characteristic of an amorphous material. A slight increase in the intensity of this amorphous peak is observed as the material is stretched, but no well-resolved peaks indicative of crystalline domains are observed at any strain. The theoretical SAXS profiles were fitted to the experimental values over a broad range of scattering vectors q with 99% confidence bounds for parametric fit. SAXS analysis confirmed the results observed by WAXS, indicating no signs of crystallization during tensile strain. These results confirm that strain hardening in these materials is unrelated to a crystallization event. A broad, low intensity peak was observed at 0% strain, confirming the amorphous state of the polymer. As the sample was stretched, this signal becomes stronger, narrows, and slowly shifts to lower q values, suggesting the formation of long-range order during deformation.

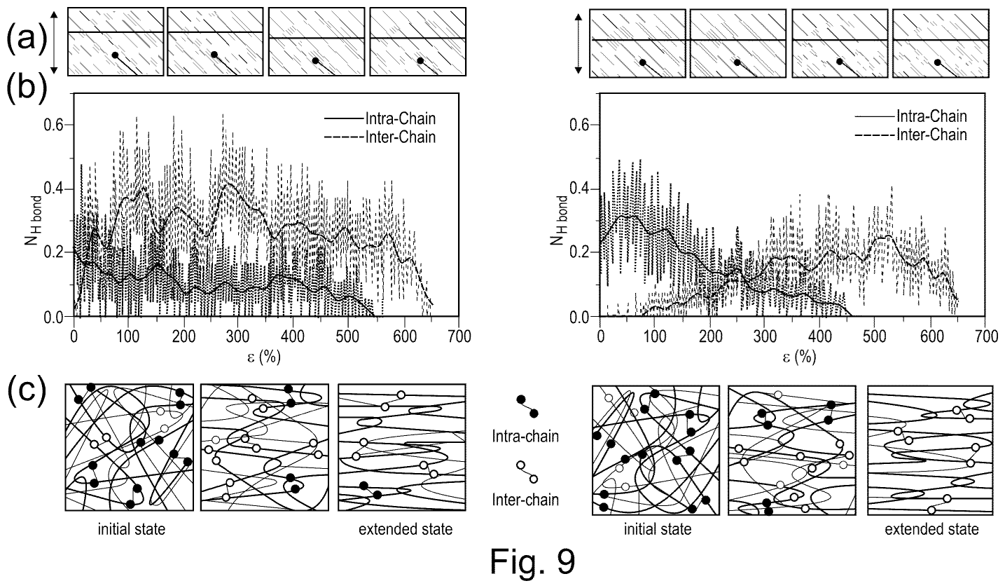

With regards to stereochemistry, the computational investigations and scattering studies suggest that intramolecular hydrogen bonds are more easily reformed in ISPU than in IMPU (FIG. 9B).

This is consistent with the experimental conclusion that ISPU is a stronger material than IMPU, because the reformation of bonds enables more continuous dissipation of energy during deformation. Additionally, slow rates of extension allow for localized relaxation which facilitates the reformation of intramolecular bonds. This resulted in ISPU exhibiting a superior strength and elasticity when stretched at 2 mm/min than when stretched at 10 mm/min. On the other hand, extended chain conformations appeared to restrictthe reformation of intramolecular bonds in IMPU. This is evidenced by the slow recovery of IMPU relative to ISPU. Since intramolecular hydrogen bonds cannot be readily reformed when the IMPU chains are extended, intermolecular bonds are more likely to reform during elastic recovery. This effectively crosslinks the network more densely and hinders recovery to an equilibrium state (FIG. 9C).

The clarity and scattering experiments lend credence to the computational observations that the strain hardening is caused by a transition from intramolecular to intermolecular H-bonding during elongation. To further probe this using experimental methods, two additional polymers lacking either the isohexide units or the urethane groups were synthesized. The first was a saturated polyurethane (SAT PU) in which the sugar unit was replaced with a four-carbon alkyl chain. Thermal analysis of SAT PU by DSC clearly revealed a semi-crystalline structure, as evidenced by the presence of distinct crystallization and melting transitions. The second polymer was a non-urethane isosorbide-based material (ISNU), in which the urethane group was replaced with an ester. Thermal analysis of ISNU showed that it also undergoes a melt transition, suggesting a semi-crystalline structure.

TABLE 2
Characterization of ISPU and IMPU compared to non-urethane and saturated urethane analogues

| | | | Tg | Tₘ | T_{c} | Strain at | Stress at | E | Tₒₙₛₑₜ |
|---|---|---|---|---|---|---|---|---|---|
| Polymer | M_{w}^{a} | Ð_{w}^{a} | (° C.)^{b} | (° C.)^{b} | (° C.)^{b} | Break (%)^{c} | Break (MPa)^{c} | (MPa)^{c} | (° C.)^{d} |
| ISPU | 109.5 | 11.08 | 13 | — | — | 1466 ± 81 | 75.1 ± 3.6 | 7.5 ± 0.4 | 302 |
| IMPU | 56.5 | 7.86 | 18 | — | — | 1806 ± 69 | 63.5 ± 2.3 | 44.2 ± 7.8 | 301 |
| ISNU | 138.1 | 6.71 | −15 | 48 | — | 139 ± 10 | 14.0 ± 2.8 | 5.2 ± 0.5 | 347 |
| SAT PU | 139.4 | 4.71 | −24 | 96 | 60 | 153 ± 1 | 43.2 ± 0.7 | 91.0 ± 1.5 | 301 |

^{a}Determined by SEC in DMSO
^{b}Determined by DSC
^{c}Determined by uniaxial extension until failure
^{d}Determined by TGA

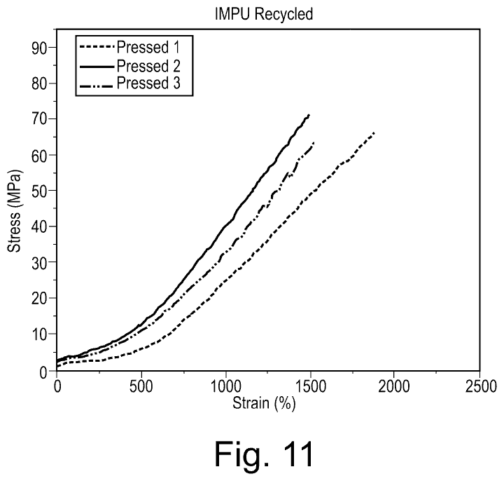

Uniaxial tensile testing showed that ISNU and SAT PU had ultimate tensile strengths of 14.0±2.8 MPa and 43.2±0.7 MPa and elongations at break of 139±10 MPa and 153±1 MPa, respectively. Neither of these materials exhibited strain dependent behavior similar to ISPU or IMPU. (FIG. 11B). The SAT PU material had a yield point at low strain that was followed by a strain hardening until failure. However, the extent of hardening was notably less significant than in ISPU or IMPU, which resulted in lower tensile strength and elongation at break. Alternatively, the non-urethane analogue was extremely soft. The tensile strength of this material could be improved by annealing for longer durations (See Example 3: Figure S23), but this only increased the stress at failure to an average of 14.0 MPa. Dynamic WAXS and SAXS analyses of ISNU showed a broad peak characteristic of an amorphous material. In SAT PU, crystallization peaks were observed under tension. These results demonstrate that both the rigid sugar moiety and the strong H-bonding groups in the backbone are necessary to achieve significant strain hardening without crystallization, confirming the results from simulations.

Lastly, the recyclability of IMPU was investigated to show that the physically crosslinked network improved the end-of-life options for these materials. Broken tensile bars and scraps of polymer film were recompressed at 120° C. to make “recycled” IMPU films. The process was repeated to make films that were “recycled” a second time. The mechanical performance was evaluated by uniaxial deformation until failure at a rate of 10 mm/min. The thermally reprocessed samples broke at lower strains than the original samples but could still be easily extended beyond 1000% strain. The reprocessing did not have a significant effect on the ultimate tensile strength of IMPU.

D. Conclusions

In this work, the synthesis of thermoplastic polyurethanes containing renewably sourced isosorbide or isomannide units in their backbones was presented. The resultant polymers were shown to be thermally stable and could be compressed into optically transparent polymer films. The rigid 1,4:3,6-dianhydrohexitol and the urethane groups facilitated stereoisomer dependent dynamic crosslinking of the materials via hydrogen bonding. Mechanical analysis demonstrated that this type of transient network interaction imparts outstanding, strain rate dependent mechanical properties characterized by high tensile strength, high elongation at break, and significant strain hardening without strain induced crystallization or the use of composite fillers. Atomistic molecular dynamics simulations of ISPU and IMPU chains revealed that these unique properties are caused by a transition from intramolecular to intermolecular hydrogen bonding dynamics during deformation. This exchange was shown to be dependent on the stereochemistry of the 1,4:3,6-dianhydrohexitol, as ISPU was more readily able to reform intramolecular hydrogen bonds in an extended chain conformation than IMPU. The computational conclusions were experimentally verified using dynamic WAXS and SAXS to confirm that the materials do not undergo strain induced crystallization during extension. Additionally, polymer analogues lacking either sugar units or urethane groups were synthesized, both of which exhibited lower strength and extensibility than either ISPU or IMPU. Lastly, reprocessing of IMPU was shown to minimally impact mechanical performance, which demonstrates the improved end-of-life options for these materials. Overall, the renewably sourced feed, excellent mechanical properties, high optical clarity, and facile reprocessing make these materials outstanding sustainable alternatives to commercial elastomers.

E. Materials and Methods

Materials: All reagents were purchased from Merck (Sigma Aldrich) unless noted and were used without further purification unless detailed. 1,8-Octane dithiol (>97%) was distilled prior to use and stored under an inert atmosphere. Dimethylphenyl phosphine (99%) was purchased in an ampule and stored under an inert atmosphere once opened. Isosorbide was recrystallized from ethyl acetate prior to use.

Preparation of Isosorbide Diacrylate Urethane (ISDAU): 2-isocyanatoethyl acrylate (20.7 mL, 166 mmol) and dibutyltin dilaurate (81 μL, 136 μmol) were added to a solution of isosorbide (10.0 g, 146 mmol) in dry THF (60 mL) while stirring. The reaction mixture was stirred overnight at ambient temperature. The product was isolated via precipitation by removing the majority of the THF in vacuo followed by the addition of diethyl ether (100 mL). The resulting solid was collected by vacuum filtration and subsequently re-crystallized from toluene:isopropyl alcohol (80:20) to yield ISDAU as a white crystalline solid (23.3 g, 54.4 mmol), 80% yield. ¹H NMR (400 MHz, DMSO-d6) δ 7.53 (t, J=5.8 Hz, 0.91H), 7.49 (t, J=5.8 Hz, 0.91H), 7.14 (s, 0.09H), 7.06 (s, 0.09H), 6.35 (d, J=17.3 Hz, 2H), 6.15 (dd, J=17.3, 10.3 Hz, 2H), 5.94 (d, J=10.4 Hz, 2H), 5.05-4.95 (m, 1H), 4.92 (d, J=3.3 Hz, 1H), 4.73-4.61 (m, ¹H), 4.37 (d, J=4.9 Hz, ¹H), 4.16-4.04 (m, ⁴H), 3.91-3.76 (m, ³H), 3.63 (dd, J=9.7, 4.9 Hz, 1H), 3.31-3.15 (m, ⁴H). ¹³C NMR (101 MHz, DMSO-d6) δ 165.40, 165.39, 155.58, 155.36, 131.64, 128.25, 85.54, 80.76, 77.76, 73.57, 72.79, 70.02, 62.89, 62.87. HRMS (ESI+, m/z) Calculated for C₁₈H24N₂O₁₀Na, requires 451.1329 found 451.1330.

Preparation of Isomannide Diacrylate Urethane (IMDAU): 2-isocyanatoethyl acrylate (20.7 mL, 166 mmol) and dibutyltin dilaurate (81 μL, 136 μmol) were added to a solution of isomannide (10.0 g, 146 mmol) in dry THF (60 mL) while stirring. The reaction mixture was stirred overnight at ambient temperature. The product was isolated via precipitation by removing the majority of the THF in vacuo followed by the addition of diethyl ether (100 mL). The resulting solid was collected by vacuum filtration and subsequently recrystallized from toluene:isopropyl alcohol (80:20) to yield IMDAU as a white crystalline solid (22.1 g, 51.7 mmol), 76% yield. ¹H NMR (400 MHz, DMSO) δ 9.91 (s, ²H), 7.44 (d, J=5.8 Hz, ¹H), 6.38 (s, ¹H), 6.97-4.35 (m, ⁸H), 4.10 (s, ²H), 4.31-3.41 (m, ⁴H), 4.31-3.40 (m, ⁴H), 4.31-2.83 (m, ⁶H), 2.83-2.45 (m, ³H). ¹³C NMR (101 MHz, DMSO) δ 165.88, 156.06, 132.12, 70.18, 63.36, 40.29, 39.77, 39.56, 39.35. HRMS (ESI+, m/z) Calculated for C₁₈H24N₂O₁₀Na, requires 451.1329 found 451.1331.

Preparation of 1,4-Butanediol Diacrylate Urethane (BDDU): A single neck 100 mL round bottom flask was charged with 1,4-butanediol (4.5 g, 50 mmol, 1.00 equiv) dissolved in THF (26 mL) and cooled to 0° C. with an ice bath. The solution was stirred and 2-isocyanatoethyl acrylate (14.8 g, 105 mmol, 2.10 equiv) was charged via syringe into the round bottom flask. DBTDL (60 μL, 0.2 mol %) was added to the solution and left to stir overnight ca. 16 h. During this time a white precipitate was formed. The remaining solvent was then removed under vacuum. The resulting white powder was purified by recrystallization from EtOAc/Hexanes to afford BDDU as a white crystalline solid (15.4 g, 83%). ¹H NMR (400 MHz; 298 K; CDCl₃) 6.46-6.40 (dd, J=24, 1.6 Hz, ²H, HHC═CH) 6.17-6.08 (dd, J=36.2, 14 Hz, ²H, H₂C═CH) 5.88-5.84 (dd, J=12.2 Hz, ²H, HHC═CH) 5.00 (s broad due to rotamers, ²H, O═C—NH) 4.23 (t, J=7.2 Hz, 4H, O—CH₂—CH₂) 4.09 (s, 4H, O—CH₂—CH₂—NH) 3.51-3.46 (q, J=7.2 Hz, ⁴H, H₂C—CH₂—NH) 1.68 (m, ⁴H, CH₂—CH₂—O) ¹³C NMR (100.57 MHz; 298 K; CDCl₃) 166.24, 156.69, 131.63, 128.14, 64.78, 63.76, 40.27, 25.77. FTIR 3349 (N—H) 1710 (C═O ester) 1683 (C═O urethane) 1631 cm-1 (C═C). HRMS (ESI-TOF) (m/z): [M+H]+ calculated for C₁₆H₂₄N₂O₈Na, 395.1430; found, 395.1432.

Preparation of Isosorbide Diacrylate Ester (ISDE): A flask was charged with isosorbide (8.00 g, 54.7 mmol) and dry CH2Cl2 (100 mL) under N₂. Dry NEt3 (17.6 mL, 126 mmol) was added in one portion and the reaction was cooled to 0° C. Acryloyl chloride (9.78 mL, 120 mmol) in dry CH₂Cl₂ (50 mL) was added dropwise to the reaction over 2 h to control any exotherm. On complete addition the reaction was stirred overnight at ambient temperature. Reaction completion was confirmed by thin layer chromatography (50:50 ethyl acetate:hexane) and the precipitated triethylammonium chloride was removed by filtration. The filtrate was washed with ¹N HCl solution (2×50 mL), saturated sodium bicarbonate solution (2×50 mL), saturated sodium chloride solution (100 mL) and dried over NaSO₄. Volatiles were removed in vacuo to yield the crude compound as an orange solid. Purification by silica-gel column chromatography (50:50 ethyl acetate:hexane) furnished a white crystalline solid (9.36 g, 37.1 mmol), 67% yield. ¹H NMR (400 MHz, Chloroform-d) δ 6.52-6.37 (m, ²H), 6.29-6.00 (m, 2H), 5.94-5.81 (m, ²H), 5.31-5.18 (m, ²H), 4.94-4.84 (m, ¹H), 4.54 (d, J=4.6 Hz, ¹H), 4.06-3.94 (m, ³H), 3.91-3.80 (m, 1H). ¹H NMR data is in agreement with the literature. ¹³C NMR (101 MHz, Chloroform-d) δ 165.54, 165.22, 132.00, 131.92, 127.88, 127.76, 86.08, 81.00, 78.23, 74.19, 73.57, 70.49. HRMS (ESI+, m/z) Calculated for C₁₂H₁₄O₆Na, requires 277.0688 found 277.0689.

Preparation of 1,8-Octanedithiol Isosorbide Polyurethane (ISPU): To a stirred solution of ISDAU (4.63 g, 10.8 mmol) in chloroform was added 1,8-octanedithiol (1.93 g, 10.8 mmol) followed by a catalytic amount of dimethylphenyl phosphine (30.7 μL, 0.216 mmol). The reaction mixture was stirred at 50° C. for 16 h. After 16 h, the reaction mixture was cooled to ambient temperature and diluted with chloroform (50 mL). The polymer was precipitated from solution by dropwise addition into diethyl ether (1000 mL) whilst stirring to give a white rubbery solid which was further washed with diethyl ether (500 mL). The polymer was dried in a vacuum oven for 5 h at 90° C. to give an off-white solid (6.13 g), 93% yield. ¹H NMR (400 MHz, DMSO) δ 4.86 (dd, J=21.9, 4.1 Hz, ²H), 4.59 (s, ¹H), 4.29 (d, J=4.8 Hz, ¹H), 3.94 (t, J=5.1 Hz, ⁵H), 3.74 (dd, J=16.7, 7.5 Hz, ³H), 3.25 (s, ⁹H), 3.13 (dd, J=5.5, 3.3 Hz, ⁵H), 2.66-2.55 (m, ⁴H), 2.55-2.35 (m, ²⁸H), 1.42 (d, J=7.4 Hz, ³H), 1.39-1.03 (m, ¹⁰H). ¹³C NMR (101 MHz, DMSO) δ 86.02, 81.23, 78.21, 74.03, 73.27, 70.47, 63.25, 34.84, 31.43, 29.48, 28.82 (d, J=39.7 Hz), 26.57. Mw=56.5 kg mol−1. ÐM=7.86.

Preparation of 1,8-Octanedithiol Isomannide Polyurethane (IMPU): To a stirred solution of IMDAU (4.6 g, 10.8 mmol) in chloroform was added 1,8-octanedithiol (1.93 g, 10.8 mmol) followed by a catalytic amount of dimethylphenyl phosphine (30.7 μL, 0.216 mmol). The reaction mixture was stirred at 50° C. for 16 h. After 16 h, the reaction mixture was cooled to ambient temperature and diluted with chloroform (50 mL). The polymer was precipitated from solution by dropwise addition into diethyl ether (1000 mL) whilst stirring to give a white rubbery solid which was further washed with diethyl ether (500 mL). The polymer was dried in a vacuum oven for 5 h at 90° C. to give an off-white solid (5.73 g), 87% yield. ¹H NMR (400 MHz, DMSO) δ 7.43 (t, J=5.8 Hz, ¹H), 4.90 (d, J=4.9 Hz, ¹H), 4.56 (d, J=3.9 Hz, ¹H), 4.02 (td, J=5.8, 1.8 Hz, ³H), 3.91 (dd, J=8.8, 6.5 Hz, ¹H), 3.70-3.52 (m, ¹H), 3.34 (s, ¹H), 3.22 (dd, J=7.9, 3.5 Hz, ⁴H), 2.69 (dd, J=10.9, 3.8 Hz, ³H), 2.64-2.43 (m, ¹⁶H), 1.49 (dd, J=14.6, 7.5 Hz, ³H), 1.45-1.11 (m, 5H). ¹³C NMR (101 MHz, DMSO) δ 80.65, 74.04, 70.17, 63.27, 39.70, 34.84, 31.42, 29.47, 29.02, 28.63, 26.55. Mw=109.5 kg mol−1. ÐM=11.08.

Preparation of 1,8-Octanedithiol Isosorbide Polyester (ISNU): To a stirred solution of IDAE (1.97 g, 7.81 mmol) in N,N-dimethylformamide (30 mL) was added 1,8-octanedithiol (1.39 g, 7.81 mmol) followed by a catalytic amount of dimethylphenyl phosphine (22.2 μL, 0.156 mmol). The reaction mixture was stirred at 50° C. for 16 h. After 16 h, the reaction mixture was cooled to room temperature and diluted with chloroform (30 mL). The polymer was precipitated from solution by dropwise addition into diethyl ether (500 mL) whilst stirring to give a white rubbery solid which was further washed with diethyl ether (2×500 mL). The polymer was dried in a vacuum oven for 5 h at 90° C. to give a white solid (2.81 g), 84% yield. ¹H NMR (400 MHz, Chloroform-d) δ 5.24-5.21 (m, ¹H), 5.20-5.14 (m, ¹H), 4.87-4.81 (m, ¹H), 4.49 (d, J=4.8 Hz, ¹H), 3.97 (d, J=2.4 Hz, ²H), 3.94 (dd, J=9.9, 5.9 Hz, ¹H), 3.81 (dd, J=9.9, 5.2 Hz, ¹H), 2.84-2.71 (m, ⁴H), 2.69-2.59 (m, ⁴H), 2.57-2.46 (m, ⁴H), 1.61-1.52 (m, ⁴H), 1.40-1.32 (m, ⁴H), 1.31-1.24 (m, ⁴H). ¹³C NMR (101 MHz, CDCl₃) δ 171.51, 171.18, 86.01, 80.88, 78.30, 74.24, 73.50, 70.52, 34.82, 34.71, 32.30, 32.25, 29.62, 29.23, 28.91, 26.99, 26.96. Mw=136.1 kg mol−1. ÐM=6.71.

Preparation of 1,8-Octanedithiol Isosorbide Polyester (ISPE): To a stirred solution of IDAE (1.97 g, 7.81 mmol) in N,N-dimethylformamide (30 mL) was added 1,8-octanedithiol (1.39 g, 7.81 mmol) followed by a catalytic amount of dimethylphenyl phosphine (22.2 μL, 0.156 mmol). The reaction mixture was stirred at 50° C. for 16 h. After 16 h, the reaction mixture was cooled to room temperature and diluted with chloroform (30 mL). The polymer was precipitated from solution by dropwise addition into diethyl ether (500 mL) whilst stirring to give a white rubbery solid which was further washed with diethyl ether (2×500 mL). The polymer was dried in a vacuum oven for 5 h at 90° C. to give a white solid (2.81 g), 84% yield. ¹H NMR (400 MHz, Chloroform-d) δ 5.24-5.21 (m, ¹H), 5.20-5.14 (m, ¹H), 4.87-4.81 (m, ¹H), 4.49 (d, J=4.8 Hz, ¹H), 3.97 (d, J=2.4 Hz, ²H), 3.94 (dd, J=9.9, 5.9 Hz, ¹H), 3.81 (dd, J=9.9, 5.2 Hz, ¹H), 2.84-2.71 (m, 4H), 2.69-2.59 (m, ⁴H), 2.57-2.46 (m, ⁴H), 1.61-1.52 (m, ⁴H), 1.40-1.32 (m, ⁴H), 1.31-1.24 (m, ⁴H). ¹³C NMR (101 MHz, CDCl₃) δ 171.51, 171.18, 86.01, 80.88, 78.30, 74.24, 73.50, 70.52, 34.82, 34.71, 32.30, 32.25, 29.62, 29.23, 28.91, 26.99, 26.96. Mw=136.1 kg mol−1. ÐM=6.71.

Polymer Film Formation: Thin polymer films were prepared using a Specac Atlas™ Manual Hydraulic Press 15T fitted with Specac heated plates. Films with a thickness of 0.5±0.05 mm were prepared by melt compressing the polymers under ca. 5 kN of force at 120° C. followed by cooling to room temperature in the press whilst under compression. To ensure consistency in the film thickness a rectangular steel spacer (0.5 mm) was employed. The machine was preheated to 120° C. and then polymer was added into the 40×50×0.5 mm mold between PTFE sheeting (0.5 mm thickness) and placed into the compression machine with heated platens touching the PTFE. After 12 min of melting the polymer was compressed with 2.5 T of pressure and released five times to ensure that no bubbles were present in the films. Next, 5 T of pressure was applied for 4 min. The press was then cooled to room temperature whilst maintaining 5 T of pressure on the sample. The sample was then removed from the machine and carefully removed from the mold. Visual inspection of the films was carried out to ensure no bubbles were present before use.

Nuclear Magnetic Resonance (NMR) Spectroscopy: All NMR spectra were recorded in deuterated chloroform (99.8% D) or deuterated dimethylsulfoxide (DMSO-d6) on a Bruker 400 MHz spectrometer with chemical shifts reported in parts per million (ppm) relative to the internal standard (TMS) and coupling constants (J) are reported in Hertz (Hz).

Thermogravimetric Analysis (TGA): TGA was obtained using a Discovery TGA550 Auto (TA instruments). TGA thermograms were recorded under an N₂ atmosphere at a heating rate of 10 K min−1, from 0° C. to 500° C., with an average sample weight of ca. 10 mg. Aluminum pans were used for all TGA experiments. Decomposition temperatures were reported as the onset temperature of decomposition (Tonest).

Differential Scanning Calorimetry (DSC): DSC was carried out using a STARe system DSC3 (Mettler Toledo, Switzerland). DSC calorigrams were recorded under N₂ purge at standard heating and cooling rates of 10 K min−1, from −50° C. to 150° C., with a sample weight of 5-10 mg in 40 uL aluminum pan. All DSC data are reported as first run data (heating cycle) unless otherwise stated. The glass transition temperatures (Tg) were determined from the minimum of the first derivative of the exotherm transition in the first heating cycle of the DSC.

Mechanical Testing: Mechanical characteristics were investigated using a Testometric MC350-5CT with a 100 or 5 kgF cell. All samples were measured using a 100 kgF cell except for C8 IS PE annealed at 25° C. for 1 week which was measured using a 5 kgF cell. Measurements of uniaxial deformation until failure and stress recovery were performed at room temperature (22±1° C.) using the compression molded films cut into dumbbell-shaped samples using a custom ASTM Die D-638 Type V with a hand press. The gauge length was set at 7.1 mm and the crosshead speed set to 2 mm min−1, 10 mm min−1, or 100 mm min−1. The sample width (ca. 1.60 mm) and thickness (ca. 0.5 mm) were measured for each individual sample before mechanical analysis was conducted. Samples were tested after annealing for 7 days at 25° C. For uniaxial deformation experiments, a minimum of three specimens were tested for each sample with the mean average and standard deviation of the values reported herein. In the elastic recovery experiment zero-force, was maintained after uniaxial deformation to 750% strain and stress was recorded as a function of time.

Rheoloqy: Rheology was performed on an Anton Paar MCR 302 using a PP8 geometry on discs (8×1 mm) cut out of homopolymer films. Temperature was controlled with a P-PTD 200/AIR Peltier and a P-PTD 200 hood. Frequency sweeps were performed at 1% strain from 0.1 to 100 rad s−1 at 5° C. intervals (between the temperatures of 120° C.-150° C. for ISPU and 100° C.-130° C. for IMPU). G′ and G″ were overlayed to a single spectrum at a reference temperature of 130° C. by applying a Williams-Landel-Ferry (WLF) time-temperature superposition. Molecular entanglement was extracted by fitting polydisperse double reptation theory in the REPTATE software package. Molecular weights obtained from SEC, were discretized to 20 values per decade and used as theory input. The adjustable parameters in the fitting were Ge (Entanglement modulus) Me (entanglement molecular weight) τe (Rouse time of one entangled segment) and the value of M0 was kept to a value of 0.001 kg·mol−1 as recommended.

Optical clarity experiment: A polymer film annealed for 7 days was cut into a bar (10×3×0.5 mm) and clamped into a Testometric M100-1CT fitted with a 10 kN load cell and a preload force of 0.1 N was applied. The fiber optic detector attached to the Ocean optics USB2000+ module was clamped behind the polymer bar ensuring the detector was covered by the polymer films. A white light source was produced from an Epson Powerlite projector and positioned 20 cm in front of the polymer film. The sample was elongated at a rate of 10 mm/min. The photospectrometer was set to sample at a rate of 3 times a minute until sample breakage, the sample was then removed, and a final spectrum is taken without the polymer sample between the spectrometer and the light source.

Small-angle X-ray Scattering (SAXS) and Wide-angle X-ray Scattering (WAXS): SAXS and WAXS measurements were carried out on dumbbell-shaped samples (prepared as stated previously) at the University of Warwick using a Linkam Scientific TST250V Tensile Testing System. Samples were measured whilst under vacuum whilst the temperature was maintained at 22° C. with 10 min SAXS/WAXS collections after each 7.5 mm pull at a rate of 10 mm/min.

Simulations: Atomistic molecular dynamics simulations were performed to elucidate effect of the chain deformation on evolution of the hydrogen bonds. The General Amber Force Field34 (GAFF) was used to model the isosorbide-containing polyurethanes (See Example 3: Figure S25). The forces on the atoms were calculated by differentiating the potential energy of the system, which consisted of bonded (bonds, angle, dihedral, and improper potentials) interactions as well as nonbonded interactions (van de Waals and electrostatic).

$$U = {\sum }_{Bonds} {{k}_{r} ( r - {r}_{eq} )}^{2} + {\sum }_{Angles} {{k}_{θ} ( θ - {θ}_{eq} )}^{2} + {\sum }_{Dihedrats} {k}_{d} [ 1 + d cos ( n ϕ ) ] + {\sum }_{i < j} ( 4 {ϵ}_{ij} [ {( \frac{σ}{{r}_{ij}} )}^{12} - {( \frac{σ}{{r}_{ij}} )}^{6} ] + \frac{{q}_{i} {q}_{j}}{4 π {ε}_{0} ε {r}_{ij}} ) \qquad ( 1 )$$

where ε₀=8.85×10⁻¹² F m⁻¹ is dielectric permittivity of the vacuum, Er is a medium relative dielectric constant.

In GAFF, the van de Waals interactions are represented by the Lennard-Jones (LJ) potentials with parameters given for each homogeneous atomic pairs (rᵢᵢ and ϵᵢᵢ), while the parameters for heterogeneous pairs are determined as rᵢⱼ=rᵢ+rⱼ and ϵᵢⱼ=√ϵᵢϵⱼ. The LJ potential is truncated at a cutoff distance of 10 A. The weighting coefficient for the 1-4 interaction was set to 0.5 for the LJ-interactions and 0.833 for the Columbic interactions. Partial charge distributions were obtained from DFT calculations using B3LYP 6-31G* (d,p) basis set for AM1 optimized structures. These simulations were done by using Gaussian 09. Note that the partial charges are averaged for atoms with same chemical environment for simplicity (see Example 3: Figure S28). The interaction parameters for non-bonded/bonded interactions are summarized in Example 3: Table S2.

The information about macromolecular structure (list of bonds, angles, dihedrals, improper dihedrals) was generated by Topotools plugins in VMD. Each polymer chain had 16 repeating units. (see Example 3: Figure S28). The two ends of each polymer chain were connected across the periodic boundary along x direction forming a loop representing an infinitely long polymer chain. There were two identical chains in the periodic simulation box with equilibrium dimensions Lx=80 A and Ly=Lz=40 A. These polymer chains adopted a bundle-like conformation. The system was equilibrated for 5000 ns. After completion of the equilibration step the simulation box was deformed along x-direction with a constant strain rate 2.5*10⁻⁶ fs⁻¹. During deformation process, the atom velocities in y and z directions were coupled to thermostat to maintain system temperature. All simulations were performed using the following setup: PPPM method for calculations of the electrostatic interactions with targeted accuracy 10⁻⁴, vacuum dielectric constant E=1.0, T=293K, Langevin thermostat (damping parameter 10 fs), and time step □t=0.5 fs. All simulations were performed using LAMMPS with GPU acceleration.

TABLE S1
Entanglement molecular weight (Mw), plateau modulus
(Ge), and rouse time (τe) of ISPU and IMPU.

| Polymer | Mₑ (kDa) | Gₑ (GPa) | τₑ (μs) |
|---|---|---|---|
| ISPU | 5.4 | 3.4 | 8.1 |
| IMPU | 5.7 | 5.3 | 3.9 |

TABLE S2
Interaction Parameters

| id | Atom Types | Mass(g/mol) | ∈ (kCal/mol) | σ(A) | Description |
|---|---|---|---|---|---|
| 1 | C | 12.0107 | 0.086 | 3.39967 | sp² C in Carboxyl group |
| 2 | C3 | 12.0107 | 0.1094 | 3.39967 | sp³ C in Aliphatic chain |
| 3 | HC | 1.00794 | 0.0157 | 2.649533 | H bonded to sp³ C |
| 4 | HN | 1.00794 | 0.0157 | 1.069078 | H bonded to N |
| 5 | N | 14.0067 | 0.17 | 3.249999 | sp² N in amide groups |
| 8 | O | 15.9994 | 0.21 | 2.959922 | O double bonded in carboxyl |
| | | | | | group |
| 7 | OS | 15.9994 | 0.17 | 3.000012 | O in ester/ether bond |
| 8 | SS | 32.065 | 0.25 | 3.563595 | sp³ S in in thio-ester |
| | | | | | and thio-ether |

| id | Bond Types | k_{d} (kCal/mol A⁻²) | τ_{eq} (A) | Description |
|---|---|---|---|---|
| 1 | C—C3 | 328.3 | 1.508 | C—C bond between aliphatic C and carboxyl group |
| 2 | C3—N | 478.2 | 1.345 | N—C bond between aliphatic C to amino group N |
| 3 | C—O | 648 | 1.214 | O—C double bond in carboxyl group |
| 4 | C—OS | 411.3 | 1.343 | O—C single bond in carboxyl group |
| 5 | C3—C3 | 303.1 | 1.535 | C—C bond between aliphatic C |
| 6 | C3—HC | 337.3 | 1.092 | C—H bond in aliphatic C chain |
| 7 | C3—N | 330.6 | 1.46 | C—N bond in amide group |
| 8 | C3—OS | 301.5 | 1.439 | C—O bond in ester bond |
| 9 | C3—S | 225.8 | 1.821 | C—S bond in thio-ether bond |
| 10 | HN—N | 410.2 | 1.009 | N—H bond in amide group |

| id | Angle Types | k_{d} (kCal/mol rad⁻²) | θ_{eq} (degree) |
|---|---|---|---|
| 1 | C—C3—C3 | 63.8 | 110.53 |
| 2 | C—C3—HC | 47.2 | 109.68 |
| 3 | C—N—C3 | 63.9 | 121.35 |
| 4 | C—N—HN | 49.2 | 118.46 |
| 5 | C—OS—C3 | 63.6 | 115.14 |
| 6 | C3—C—O | 68 | 123.11 |
| 7 | C3—C—OS | 69.3 | 111.96 |
| 8 | C3—C3—C3 | 63.2 | 110.63 |
| 9 | C3—C3—HC | 46.4 | 110.05 |
| 10 | C3—C3—N | 65.9 | 112.13 |
| 11 | C3—C3—OS | 67.8 | 108.42 |
| 12 | C3—C3—S | 61.1 | 112.69 |
| 13 | C3—N—HN | 46 | 116.78 |
| 14 | C3—OS—C3 | 62.1 | 113.41 |
| 15 | C3—S—C3 | 60.6 | 99.92 |
| 16 | HC—C3—HC | 39.4 | 108.35 |
| 17 | HC—C3—N | 49.8 | 109.5 |
| 18 | HC—C3—OS | 50.9 | 108.7 |
| 19 | HC—C3—S | 42.5 | 108.76 |
| 20 | N—C—O | 75.8 | 122.03 |
| 21 | N—C—OS | 74.7 | 115.25 |
| 22 | O—C—OS | 76.2 | 122.43 |

| | Proper Dihedral | | | |
|---|---|---|---|---|
| id | Types | k_{d} (kCal/mol) | d | n |
| 1 | C—C3—C3—HC | 0.155556 | 1 | 3 |
| 2 | C—C3—C3—S | 0.155556 | 1 | 3 |
| 3 | C3—C—OS—C3 | 2.7 | −1 | 2 |
| 4 | C3—C3—C3—C3 | 0.155556 | 1 | 3 |
| 5 | C3—C3—C3—C3 | 0.18 | 1 | 3 |
| 8 | C3—C3—C3—C3 | 0.25 | −1 | 2 |
| 7 | C3—C3—C3—C3 | 0.2 | −1 | 1 |
| 8 | C3—C3—C3—HC | 0.155556 | 1 | 3 |
| 9 | C3—C3—C3—HC | 0.16 | 1 | 3 |
| 10 | C3—C3—C3—OS | 0.155556 | 1 | 3 |
| 11 | C3—C3—C3—S | 0.155556 | 1 | 3 |
| 12 | C3—C3—N—C | 0 | 1 | 2 |
| 13 | C3—C3—N—C | 0.5 | −1 | 4 |
| 14 | C3—C3—N—C | 0.15 | −1 | 3 |
| 15 | C3—C3—N—C | 0.53 | 1 | 1 |
| 16 | C3—C3—N—HN | 0 | 1 | 2 |
| 17 | C3—C3—OS—C | 0.383333 | 1 | 3 |
| 18 | C3—C3—OS—C | 0.383 | 1 | 3 |
| 19 | C3—C3—OS—C | 0.8 | −1 | 1 |
| 20 | C3—C3—OS—C3 | 0.383333 | 1 | 3 |
| 21 | C3—C3—OS—C3 | 0.383 | 1 | 3 |
| 22 | C3—C3—OS—C3 | 0.1 | −1 | 2 |
| 23 | C3—C3—S—C3 | 0.333333 | 1 | 3 |
| 24 | HC—C3—C3—HC | 0.155556 | 1 | 3 |
| 25 | HC—C3—C3—HC | 0.15 | 1 | 3 |
| 26 | HC—C3—C3—N | 0.155556 | 1 | 3 |
| 27 | HC—C3—C3—OS | 0.155556 | 1 | 3 |
| 28 | HC—C3—G3—OS | 0.25 | 1 | 1 |
| 29 | HC—C3—C3—S | 0.155558 | 1 | 3 |
| 30 | HC—C3—N—C | 0 | 1 | 2 |
| 31 | HC—C3—N—HN | 0 | 1 | 2 |
| 32 | HC—C3—OS—C | 0.383333 | 1 | 3 |
| 33 | HC—C3—OS—C3 | 0.383333 | 1 | 3 |
| 34 | HC—C3—S—C3 | 0.333333 | 1 | 3 |
| 35 | N—C—OS—C3 | 2.7 | −1 | 2 |
| 36 | N—C3—C3—OS | 0.155556 | 1 | 3 |
| 37 | O—C—C3—C3 | 0 | −1 | 2 |
| 38 | O—C—C3—HC | 0 | −1 | 2 |
| 39 | O—C—C3—HC | 0.8 | 1 | 1 |
| 40 | Q—C—C3—HC | 0.08 | −1 | 3 |
| 41 | O—C—N—C3 | 2.5 | −1 | 2 |
| 42 | O—C—N—HN | 2.5 | −1 | 2 |
| 43 | O—C—N—HN | 2.5 | −1 | 2 |
| 44 | O—C—N—HN | 2 | 1 | 1 |
| 45 | O—C—OS—C3 | 2.7 | −1 | 2 |
| 46 | O—C—OS—C3 | 2.7 | −1 | 2 |
| 47 | O—C—OS—C3 | 1.4 | −1 | 1 |
| 48 | OS—C—C3—C3 | 0 | −1 | 2 |
| 49 | OS—C—C3—HC | 0 | −1 | 2 |
| 50 | OS—C—N—C3 | 2.5 | −1 | 2 |
| 51 | OS—C—N—HN | 2.5 | −1 | 2 |
| 52 | OS—C3—C3—OS | 0.155556 | 1 | 3 |
| 53 | OS—C3—C3—OS | 0.144 | 1 | 3 |
| 54 | OS—C3—C3—OS | 1.175 | 1 | 2 |

| | Improper | | | | |
|---|---|---|---|---|---|
| id | Dihedrals | k_{d} (kCal/mol) | d | n | Description |
| 1 | C3—O—C—OS | 10.5 | −1 | 2 | CCOO plane |
| 2 | N—O—C—OS | 10.5 | −1 | 2 | NCOO plane |

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

1. A linear polymer comprising at least one subunit, wherein the at least one subunit comprises: (i) at least one dianhydrohexitole moiety; (ii) at least one urethane moiety; and (iii) a thiol moiety having two or more sulphur atoms, wherein the at least one urethane moiety comprises an oxygen atom that is a substituent of the dianhydrohexitole moiety and is formed from a hydroxyl group of the dianhydrohexitole moiety.

2-30. (canceled)

31. The linear polymer of claim 1, wherein the at least one subunit comprises a single thiol moiety, wherein the single thiol moiety comprises two sulphur atoms.

32. The linear polymer of claim 1, comprising at least a first urethane moiety and a second urethane moiety wherein the oxygen atom of each urethane moiety is a substituent of the dianhydrohexitole moiety and is formed from the hydroxyl group of the dianhydrohexitole moiety.

33. The linear polymer of claim 1, wherein the at least one subunit is selected from the group consisting of: 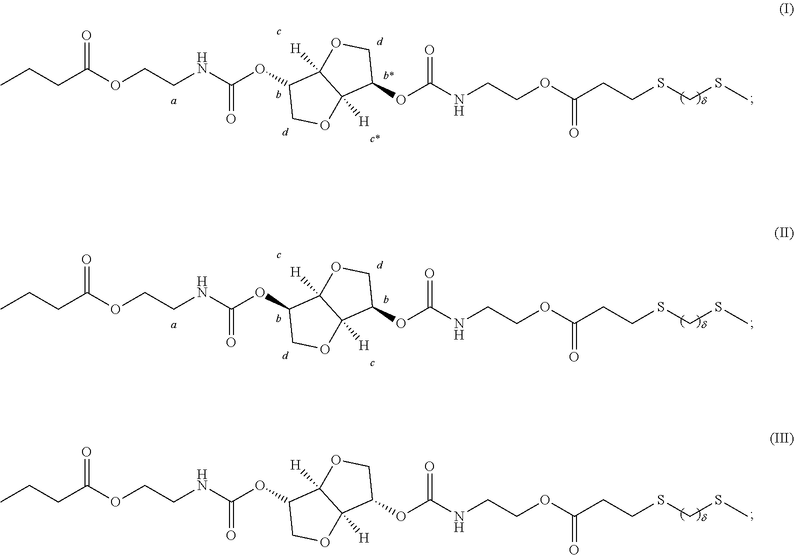
and derivatives thereof and wherein δ is from 4 to 12.

34. The linear polymer of claim 1, wherein the thiol moiety is selected from the group consisting of 1,8-octanedithiol, 1,4-butanedithiol, 1,6-hexanedithiol, 1,10-decanedithiol, and 1,12-dodecandithiol.

35. The linear polymer of claim 1, wherein the linear polymer comprises a tensile strength of at least 55 MPa.

36. A polymer comprising a physical blend selected from the group consisting of:
(a) two or more different homopolymers, wherein each homopolymer comprises at least one subunit comprising (i) at least one dianhydrohexitole moiety, (ii) at least one urethane moiety, and (iii) a thiol moiety having two or more sulphur atoms;
(b) two or more different copolymers, wherein each copolymer comprises at least a first subunit and a second subunit, each subunit comprising (i) at least one dianhydrohexitole moiety, (ii) at least one urethane moiety, and (iii) a thiol moiety having two or more sulphur atoms, wherein in each copolymer the first subunit comprises a first dianhydrohexitole moiety and the second subunit comprises a second dianhydrohexitole moiety, and the second dianhydrohexitole moiety is different to the first dianhydrohexitole moiety; and
(c) two or more different homopolymers and copolymers, wherein each of said homopolymers comprises at least one subunit comprising (i) at least one dianhydrohexitole moiety, (ii) at least one urethane moiety, and (iii) a thiol moiety having two or more sulphur atoms; and
wherein each of said copolymers comprises at least a first subunit and a second subunit, wherein each subunit comprises (i) at least one dianhydrohexitole moiety, (ii) at least one urethane moiety, and (iii) a thiol moiety having two or more sulphur atoms, wherein in each copolymer the first subunit comprises a first dianhydrohexitole moiety and the second subunit comprises a second dianhydrohexitole moiety, and the second dianhydrohexitole moiety is different to the first dianhydrohexitole moiety.

37. The polymer of claim 36, wherein each homopolymer comprises a different dianhydrohexitole moiety.

38. The polymer of claim 36, wherein each dianhydrohexitole moiety is selected from the group consisting of isodide, isosorbide, and isomannide.

39. The polymer of claim 36, wherein each subunit of the homopolymers and the copolymers is selected from the group consisting of: 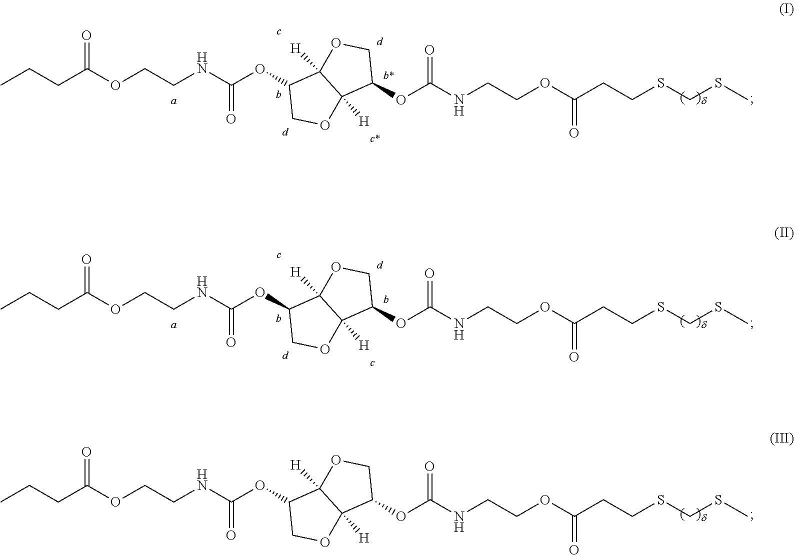
and derivatives thereof and wherein δ is from 4 to 12.

40. The polymer of claim 39, wherein the physical blend comprises at least a first homopolymer and a second homopolymer, wherein each homopolymer is different from the other homopolymers, and the first homopolymer comprises the subunit (III) (IIPU) and the second homopolymer comprises the subunit (II) (IMPU).

41. The polymer of claim 36, wherein at least one of the copolymers comprises two or more subunits in a blend comprising isodide (II) and isomannide (IM) at a ratio in a range of 75:25 (co-II75IM25) to 25:75 (co-II25IM75).

42. The polymer of claim 41, wherein the at least one of the copolymers comprises a blend selected from the group consisting of: isodide (II) and isomannide (IM) at a ratio of 75:25 (co-II75IM25); isodide (II) and isomannide (IM) at a ratio of 25:75 (co-II25IM75); and isodide (II) and isomannide (IM) at a ratio of 50:50 (co-II50IM50).

43. The polymer of claim 36, wherein the thiol moiety is selected from the group consisting of 1,8-octanedithiol, 1,4-butanedithiol, 1,6-hexanedithiol, 1,10-decanedithiol, and 1,12-dodecandithiol.

44. The polymer of claim 36, wherein the polymer comprises a tensile strength of at least 55 MPa.

45. A copolymer comprising at least a first subunit and a second subunit, wherein each subunit comprises: (i) at least one dianhydrohexitole moiety (ii) at least one urethane moiety and (iii) a thiol moiety having two or more sulphur atoms, wherein said at least one dianhydrohexitole moiety of the first subunit is different to said at least one dianhydrohexitole moiety of the second subunit.

46. The copolymer of claim 45, wherein the copolymer comprises the subunits in a blend of isodide (II) and isomannide (IM) at a ratio in a range of 75:25 (co-II75IM25) to 25:75 (co-II25IM75).

47. The copolymer of claim 45, wherein the copolymer comprises the subunits in a blend selected from the group consisting of: isodide (II) and isomannide (IM) at a ratio of 75:25 (co-II75IM25); isodide (II) and isomannide (IM) at a ratio of 25:75 (co-II25IM75); and isodide (II) and isomannide (IM) at a ratio of 50:50 (co-II50IM50).

48. The copolymer of claim 45, wherein each of the subunits is selected from the group consisting of: 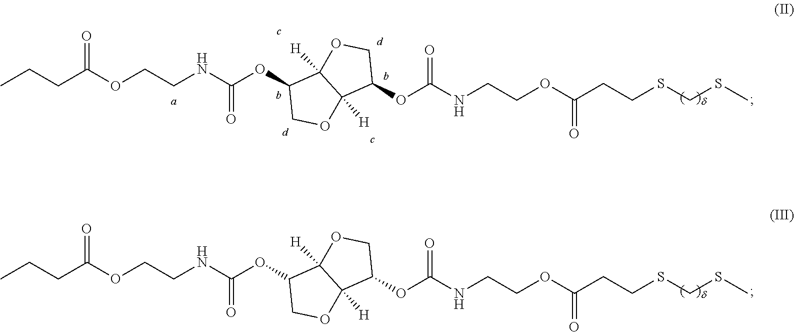
and derivatives thereof and wherein δ is from 4 to 12.

49. The copolymer of claim 45, wherein the thiol moiety is selected from the group consisting of 1,8-octanedithiol, 1,4-butanedithiol, 1,6-hexanedithiol, 1,10-decanedithiol, and 1,12-dodecandithiol.
